(19) United States
(12) Patent Application Publication
(10) Pub. No.: US 2026/0236376 A1
(43) Pub. Date: Aug. 13, 2026

(54) VEHICLE TEST CASE GENERATION USING MACHINE LEARNING

(71) Applicant: GM GLOBAL TECHNOLOGY OPERATIONS LLC, DETROIT, MI (US)

(72) Inventors: Arun Adiththan, Sterling Heights, MI (US); Prakash M. Peranandam, Rochester Hills, MI (US); Ramesh S, Troy, MI (US); Prathap Venugopal, Troy, MI (US)

(21) Appl. No.: 19/051,559

(22) Filed: Feb. 12, 2025

(51) Int. Cl. G06F 11/3668; G06F 16/3329

(52) U.S. Cl. CPC G06F 11/3684; G06F 16/33295

(57) ABSTRACT

Examples described herein provide a method for vehicle test case generation includes receiving at least one of a transactional level input/output (I/O) model based at least in part on a feature file and textual artifacts. The method further includes incrementally building behaviors from a base scenario to multiple scenarios and identifying gaps in conditions and decisions expressions in the behaviors. The method further includes building system level behaviors and generating additional scenarios based at least in part on the system level behaviors and the gaps in conditions and decisions expression in the behaviors. The method further includes generating a behavioral model based at least in part on the base scenario, the multiple scenarios, the behaviors, and the additional scenarios. The method further includes causing at least one system of a vehicle to be tested based at least in part on a test case generated using the behavioral model.

### BACKGROUND

The subject disclosure relates to vehicles, and in particular to test case generation using machine learning.

A test case is a specific scenario or set of conditions designed to evaluate the functionality, performance, or compliance of a system against its requirements and expected outcomes. Test case generation is a step in the development process of a vehicle. Test case generation in vehicle development involves creating one or more test cases to test one or more systems of a vehicle. For example, test case generation involves generating a comprehensive set of scenarios to validate the functionality, performance, safety, and reliability of various components and systems within a vehicle.

Test cases are used to test whether systems meet design specifications and regulatory standards. For example, test cases ensure vehicle systems function correctly under various conditions, meet safety and performance standards, and comply with regulations. Test cases validate functionality, support subsystem integration, and ensure reliability and user safety. Test cases include functional, performance, stress, regression, integration, safety, and edge-case tests, each targeting specific aspects of the system. Together, test cases provide a thorough framework to evaluate functionality, performance, and compliance. The test case generation process involves analyzing requirements, defining scenarios, prioritizing safety-critical cases, and automating testing where possible. Tests are executed in simulated or real environments, with results validated and issues addressed through retesting.

The need for a more efficient, systematic, and accurate approach to generate test cases remains.

### SUMMARY

In one embodiment, a method for vehicle test case generation is provided. The method includes receiving at least one of a transactional level input/output (I/O) model based at least in part on a feature file and textual artifacts. The method further includes incrementally building behaviors from a base scenario to multiple scenarios. The method further includes identifying gaps in conditions and decisions expressions in the behaviors. The method further includes building system level behaviors. The method further includes generating additional scenarios based at least in part on the system level behaviors and the gaps in conditions and decisions expression in the behaviors. The method further includes generating a behavioral model based at least in part on the base scenario, the multiple scenarios, the behaviors, and the additional scenarios. The method further includes causing at least one system of a vehicle to be tested based at least in part on a test case generated using the behavioral model.

In addition to one or more of the features described herein, or as an alternative, further embodiments of the method may include that receiving the transactional level I/O model based at least in part on the feature file further includes receiving the feature file or a feature file component.

In addition to one or more of the features described herein, or as an alternative, further embodiments of the method may include that incrementally building behaviors from a base scenario to the multiple scenarios includes reading in a first scenario of a plurality of scenarios, extracting states and communicating agents from the first scenario, calling a large language model (LLM) with a first customized prompt to covert the first scenario to a behavioral model type, calling the LLM with a second customized prompt to create or to add to the behavioral model, and iterating to a second scenario of the plurality of scenarios, and repeating the extracting and calling until each of the plurality of scenarios has been read.

In addition to one or more of the features described herein, or as an alternative, further embodiments of the method may include that incrementally building behaviors from the base scenario to the multiple scenarios further includes calling the LLM to check whether the behavioral model is complete, and implementing a human-in-the-loop phase to enable updating and checking the behavioral model.

In addition to one or more of the features described herein, or as an alternative, further embodiments of the method may include that incrementally building behaviors from the base scenario to the multiple scenarios is performed using a large language model (LLM)-based agent and is performed based in part on a model type and a prompt received from a prompt library.

In addition to one or more of the features described herein, or as an alternative, further embodiments of the method may include that identifying the gaps in conditions and decisions expressions in the behaviors includes identifying two or more conditions that occur at a same time, and modifying the behavioral model to account for the two or more conditions that occur at the same time.

In addition to one or more of the features described herein, or as an alternative, further embodiments of the method may include that identifying the gaps in conditions and decisions expressions in the behaviors includes identifying an expression logical gap, and modifying the behavioral model by adding missing transactions to account for the expression logical gap.

In another embodiment, a processing system is provided. The processing system includes a memory having computer readable instructions and a processing device for executing the computer readable instructions, the computer readable instructions controlling the processing system to perform operations for vehicle test case generation. The operations include receiving a transactional level input/output (I/O) model based at least in part on a feature file. The operations further include incrementally building behaviors from a base scenario to multiple scenarios. The operations further include identifying gaps in conditions and decisions expressions in the behaviors. The operations further include building system level behaviors. The operations further include generating additional scenarios based at least in part on the system level behaviors and the gaps in conditions and decisions expression in the behaviors. The operations further include generating a behavioral model based at least in part on the base scenario, the multiple scenarios, the behaviors, and the additional scenarios. The operations further include causing at least one system of a vehicle to be tested based at least in part on a test case generated using the behavioral model.

In addition to one or more of the features described herein, or as an alternative, further embodiments of the processing system may include that receiving the transactional level I/O model based at least in part on the feature file further includes receiving the feature file or a feature file component.

In addition to one or more of the features described herein, or as an alternative, further embodiments of the processing system may include that incrementally building behaviors from the base scenario to the multiple scenarios includes reading in a first scenario of a plurality of scenarios, extracting states and communicating agents from the first scenario, calling a large language model (LLM) with a first customized prompt to covert the first scenario to a behavioral model type, calling the LLM with a second customized prompt to create or to add to the behavioral model, and iterating to a second scenario of the plurality of scenarios, and repeating the extracting and calling until each of the plurality of scenarios has been read.

In addition to one or more of the features described herein, or as an alternative, further embodiments of the processing system may include that incrementally building behaviors from the base scenario to the multiple scenarios further includes calling the LLM to check whether the behavioral model is complete, and implementing a human-in-the-loop phase to enable updating and checking the behavioral model.

In addition to one or more of the features described herein, or as an alternative, further embodiments of the processing system may include that incrementally building behaviors from the base scenario to the multiple scenarios is performed using a large language model (LLM)-based agent and is performed based in part on a model type and a prompt received from a prompt library.

In addition to one or more of the features described herein, or as an alternative, further embodiments of the processing system may include that identifying the gaps in conditions and decisions expressions in the behaviors includes identifying two or more conditions that occur at a same time, and modifying the behavioral model to account for the two or more conditions that occur at the same time.

In addition to one or more of the features described herein, or as an alternative, further embodiments of the processing system may include that identifying the gaps in conditions and decisions expressions in the behaviors includes identifying an expression logical gap, and modifying the behavioral model by adding missing transactions to account for the expression logical gap.

In another embodiment a computer program product is provided. The computer program product includes a computer readable storage medium having program instructions embodied therewith, the program instructions executable by at least one processor to cause the at least one processor to perform operations for vehicle test case generation. The operations include receiving a transactional level input/output (I/O) model based at least in part on a feature file. The operations further include incrementally building behaviors from a base scenario to multiple scenarios. The operations further include identifying gaps in conditions and decisions expressions in the behaviors. The operations further include building system level behaviors. The operations further include generating additional scenarios based at least in part on the system level behaviors and the gaps in conditions and decisions expression in the behaviors. The operations further include generating a behavioral model based at least in part on the base scenario, the multiple scenarios, the behaviors, and the additional scenarios. The operations further include causing at least one system of a vehicle to be tested based at least in part on a test case generated using the behavioral model.

In addition to one or more of the features described herein, or as an alternative, further embodiments of the computer program product may include that receiving the transactional level I/O model based at least in part on the feature file further includes receiving the feature file or a feature file component.

In addition to one or more of the features described herein, or as an alternative, further embodiments of the computer program product may include that incrementally building behaviors from the base scenario to the multiple scenarios includes reading in a first scenario of a plurality of scenarios, extracting states and communicating agents from the first scenario, calling a large language model (LLM) with a first customized prompt to covert the first scenario to a behavioral model type, calling the LLM with a second customized prompt to create or to add to the behavioral model, and iterating to a second scenario of the plurality of scenarios, and repeating the extracting and calling until each of the plurality of scenarios has been read.

In addition to one or more of the features described herein, or as an alternative, further embodiments of the computer program product may include that incrementally building behaviors from the base scenario to the multiple scenarios further includes calling the LLM to check whether the behavioral model is complete, and implementing a human-in-the-loop phase to enable updating and checking the behavioral model.

In addition to one or more of the features described herein, or as an alternative, further embodiments of the computer program product may include that incrementally building behaviors from the base scenario to the multiple scenarios is performed using a large language model (LLM)-based agent and is performed based in part on a model type and a prompt received from a prompt library.

In addition to one or more of the features described herein, or as an alternative, further embodiments of the computer program product may include that identifying the gaps in conditions and decisions expressions in the behaviors includes identifying two or more conditions that occur at a same time, modifying the behavioral model to account for the two or more conditions that occur at a same time, identifying an expression logical gap, and modifying the behavioral model by adding missing transactions to account for the expression logical gap.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram illustrating a system for automated test case generation according to one or more embodiments;

FIG. 2 is a flow chart diagram illustrating the process of generating and visualizing feature files and transactional models for test case generation according to one or more embodiments;

FIG. 3 illustrates a flow chart diagram of a method for generating feature files and scenarios using LLM-powered agents according to one or more embodiments;

FIG. 4 illustrates a flow chart diagram depicting the chunking and categorization process of DOORS requirements into various types for test case generation according to one or more embodiments;

FIG. 5 is a flow chart diagram illustrating a method for building an ontology multigraph for comprehensive test case generation according to one or more embodiments;

FIG. 6A illustrates a flow chart diagram for identifying actors and building use case scenarios with expected outputs according to one or more embodiments;

FIG. 6B depicts a flow chart diagram for linking inputs and outputs to build a global system and generate missing expected outputs according to one or more embodiments;

FIG. 6C shows a block diagram of the organization and categorization of feature files into hierarchical levels with scenarios according to one or more embodiments;

FIG. 7 illustrates a flow chart diagram of a method for generating a transactional level I/O model from feature files and scenarios according to one or more embodiments;

FIG. 8 is a flow chart diagram illustrating the process of generating user-specific visualizations from a JSON file based on user requests according to one or more embodiments;

FIG. 9 is a flow chart diagram illustrating the process of building and refining behavioral models from feature files and I/O models using prompt engineering according to one or more embodiments;

FIG. 10 is a flow chart diagram illustrating the process of generating and updating behavioral models using LLMs from feature files and scenarios according to one or more embodiments according to one or more embodiments;

FIG. 11 is a block diagram illustrating the process of identifying gaps in conditions and decision expressions for test case generation according to one or more embodiments;

FIG. 12 is a block diagram illustrating prompt engineering for identifying gaps in conditions and decision expressions in vehicle systems according to one or more embodiments;

FIG. 13 is a flow chart diagram illustrating the process of generating component, system, and safety test cases from feature files and behavioral models according to one or more embodiments;

FIG. 14 is a flow chart diagram illustrating the process of generating and optimizing component test cases using LLMs according to one or more embodiments;

FIG. 15 illustrates a flow chart diagram of the process for synthesizing system-level test cases from component-level test cases using a dependency model according to one or more embodiments;

FIG. 16 illustrates a flow chart diagram depicting the synthesis of system-level test cases from component-level test cases, highlighting feedback dependencies and input/output relationships according to one or more embodiments;

FIG. 17 is a flow chart diagram illustrating the process of generating safety test cases for a lane keep assist safety feature using LLM-powered functional element extraction and scenario creation according to one or more embodiments; and

FIG. 18 illustrates a block diagram of a system for test case generation using machine learning according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term “controller” (e.g., a charging controller as further described herein) refers to a dedicated controller including a processor and a memory, a general controller including control modules configured to enact a control process using the dedicated controller, a network of multiple distinct controllers in communication with each other and each including processors and memory and being configured to cooperatively implement the control process, and any similar configuration for implementing the control process.

One or more embodiments described herein relates to test case generation using machine learning.

Technological systems often face challenges related to test case generation. In the development of modern vehicles, ensuring the functionality, performance, and compliance of various systems is useful to the improved functionality of the vehicles and the systems associated therewith. This is achieved through rigorous testing processes, which include the generation of test cases. Test cases are specific scenarios or sets of conditions designed to evaluate whether a system meets its requirements and expected outcomes. The process of test case generation is useful in validating the functionality, performance, safety, and reliability of vehicle components and systems. However, this process is often complex and time-consuming, requiring meticulous analysis and validation to ensure comprehensive coverage of all possible scenarios.

Existing approaches for generating test cases in vehicle development primarily rely on manual efforts at some stage of the development. Engineers and developers analyze requirements documents, design models, and use cases to create test cases that validate systems'behavior under various conditions. This manual approach is not only labor-intensive but also prone to inconsistency due to variations in know-how from person to person. Additionally, the manual generation of test cases can be time-consuming, delaying the overall development process. Additionally, the manual update of models in response to change requests introduces further inefficiencies. This approach is not only labor-intensive but also prone to behavioral gaps, making it difficult to ensure systematic and behaviorally complete models. Engineers face challenges in mapping user stories and issue verbatims to respective scenarios, signals, data types, and design descriptions, which complicates the extraction of expected outputs. Additionally, the synthesis of system-level test cases from component-level test cases is not optimized, and the generation of safety test cases is not automated. These issues collectively hinder the development of high-quality, comprehensive test cases used for ensuring the reliability and efficiency of complex systems used in vehicle. The need for a more efficient, systematic, and accurate approach to generate test cases remains.

One or more embodiments described herein introduces approaches for generating feature files and transactional models from textual requirements using large language models (LLMs) with engineered prompts. The feature file and/or transactional level model can then be used to generate a behavioral model that, in turn, is used to generate comprehensive set of test cases using LLMs with corresponding engineered prompts.

In particular, one or more embodiments described herein provides for generating feature files and transactional models from requirements using LLMs with engineered prompts. This approach systematically builds input/output (I/O) transactional models at various hierarchical levels from requirements and scenarios. By converting legacy requirements (e.g., doors requirements) into feature files and then constructing hierarchical I/O models, one or more embodiments ensures completeness and consistency in connectivity, significantly reducing the time, effort, and computational resources used for test case generation. Furthermore, one or more embodiments provides different I/O interaction visualizations tailored to various stakeholders, enhancing the overall quality and efficiency of the testing process.

One or more embodiments described herein provides for automatically generating and updating behavioral models using LLMs from textual artifacts and I/O interface models at various levels. Utilizing LLMs to automatically generate and update behavioral models significantly reduces manual effort. Textual artifacts (e.g., change requests, issue verbatims, and user stories) provide for fine-tuning and adapting existing behavioral models. Extracting key and atomic elements of behaviors, such as states and communicating agents, provide for building accurate models. Using hierarchical prompts can be used to identify transition gaps and logically fill them with human consent, ensuring completeness and accuracy. One or more embodiments provides for incrementally building behaviors using a modeling language from base scenarios to multiple/many scenarios, identifying and highlighting gaps in conditions and decision expressions, and adding missing scenarios as needed.

One or more embodiments described herein provides for leveraging a LLM to automatically generate high-quality test cases from feature files, behavioral models, user stories, and/or issue verbatims. Such one or more embodiments involves feeding a RAG (Retrieval Augmented Generation) retrieved relevant information, chain of thoughts and iterative calls to the LLM with appropriate engineered prompts to achieve optimal test case generation with comprehensive coverage analysis. The user stories and issue verbatims are mapped to respective scenarios, signals, data types, and design descriptions, enabling automatic extraction of expected outputs. One or more embodiments also includes a reuse approach to synthesize system-level test cases from component-level test cases, minimizing resource usage. Furthermore, one or more embodiments automatically generates safety test cases and performs various coverage inspections without the need for simulation. This innovative approach significantly improves the efficiency, the coverage, and the quality of test cases while reducing manual effort and time and computational resources consumed during test case generation.

Large language models are advanced artificial intelligence systems trained on vast datasets of text or other data to generate human-like responses, perform language-based tasks, and understand complex instructions. LLMs are particularly adept in performing applications like summarization, translation, content creation, and more by leveraging statistical patterns in language. The effectiveness of an LLM often depends on the instruction clarity, examples, and structure of the input it receives, referred to as a “prompt.” A prompt engineer designs and optimizes prompts to elicit accurate, relevant, and efficient responses from an LLM, aligning the LLM output with specific user goals.

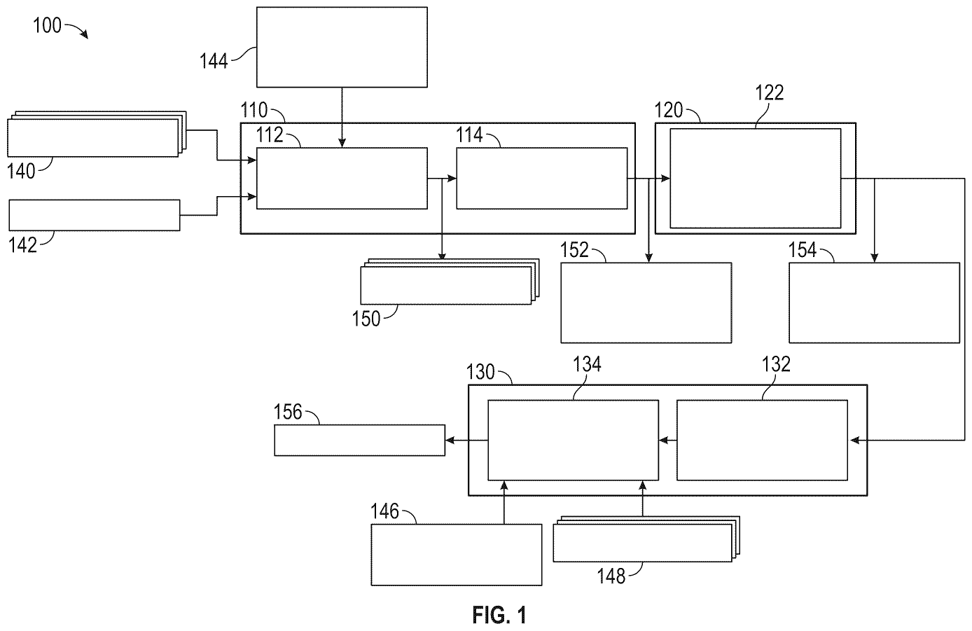

FIG. 1 illustrates a block diagram of a system 100 for test case generation using machine learning according to one or more embodiments. The system 100 is designed to automate the generation of feature files (e.g., feature file 150) and transactional models (e.g., transactional level I/O model 152) from requirements using LLMs with engineered prompts. The feature files and/or transactional level model can then be used to generate a behavioral model (e.g., behavioral model 154) that, in turn, is used to generate test cases (e.g., test cases 156).

The system 100 includes a feature file generator 112 and a transactional level (I/O) model builder 114 that execute in a first stage 110, a transactional behaviors and I/O dependency model builder 122 that executes in a second stage 120, and a component level guided test case generator 132 and a synthesis system level test case generator 134 that execute in a third stage 130.

The system 100 begins performing test case generation with the input of doors requirements 140 and other requirements 142 into the feature file generator 112. Dynamic Object-Oriented Requirements System (DOORS or “doors”) is a software tool used for capturing, managing, and tracing requirements throughout a project's lifecycle. DOORS helps teams ensure compliance, maintain traceability, and manage changes efficiently in complex systems engineering projects. “DOORS requirements” (or “doors requirements”) refer to the specific set of requirements that are captured, managed, and traced using the DOORS software. The doors requirements can include functional, non-functional, and technical specifications for a project, ensuring alignment with stakeholder demands and facilitating traceability and change management throughout the project lifecycle. The other interface related requirements 142 can be expressed in one or more other formats, such as AUTOSAR XML (ARXML), which is a standard used for exchanging and structuring data related to automotive software systems, PlantUML, which is an open-source tool used for creating diagrams from plain text descriptions, Protobuf, which is a language-agnostic, efficient serialization format for transmitting structured data between systems or storing it and/or the like, including combinations and/or multiples thereof.

The feature file generator 112 converts the given requirements into feature files, which includes a feature file 150. A feature file is a structured document that describes the desired behavior of a system or component in plain language, serving as a bridge between high-level requirements and the actual test cases used to verify those requirements. The feature file 150 may include scenarios, inputs, and expected outcomes, facilitating automated test generation and validation. The feature file 150 is then processed by the transactional level (I/O) model builder 114, which creates a transactional level I/O model 152. The transactional level model is a detailed representation of I/O interactions and dependencies within a system, capturing the flow of data and control signals between various components. The transactional level model 152 ensures that system interfaces are accurately represented, providing a foundation for generating comprehensive and consistent test cases.

The transactional behaviors and I/O dependency model builder 122 receives the transactional level model 152 and uses it to generate a behavioral model 154 by incorporating behaviors and I/O dependencies. According to one or more embodiments, the behavioral model 154 includes finite state machines (FSM) and/or message sequence charts. The behavioral model 154 captures the dynamic aspects of the system of the vehicle to be tested, detailing how different components interact over time and under various conditions. The behavioral model 154 is useful for understanding the operational logic of the system of the vehicle to be tested and for identifying potential issues in the interaction sequences.

The component level guided test case generator 132 uses the behavioral model 154 to generate guided test cases at the component level. These test cases are designed to validate the functionality of individual components, ensuring that each component behaves as expected in isolation. The guided test cases are generated based on predefined scenarios and expected outcomes, providing a comprehensive set of tests for each component. Guided test cases include a series of instructions or steps to be performed to execute the test case.

These component-level guided test cases optionally are then synthesized into system-level test cases by the synthesis system level test case generator 134. This component utilizes input dependency logic 146 and system feature files 148 to ensure comprehensive test coverage. The input dependency logic identifies the relationships between different inputs and outputs, ensuring that all possible interactions are tested. The system feature files provide additional context and constraints, guiding the synthesis process to produce accurate and relevant test cases.

The final output of the system is a set of test cases 156 that can be used to validate the functionality, performance, and reliability of the vehicle systems. These test cases cover a wide range of scenarios, including normal operation, edge cases, and failure modes. By automating the generation of the test cases 156, the system 100 ensures higher accuracy, consistency, and efficiency compared to traditional manual approaches. This automation reduces the time, effort, and computational/processing resources used to generate test cases, allowing engineers to focus on more critical tasks and improving the overall quality of the testing process.

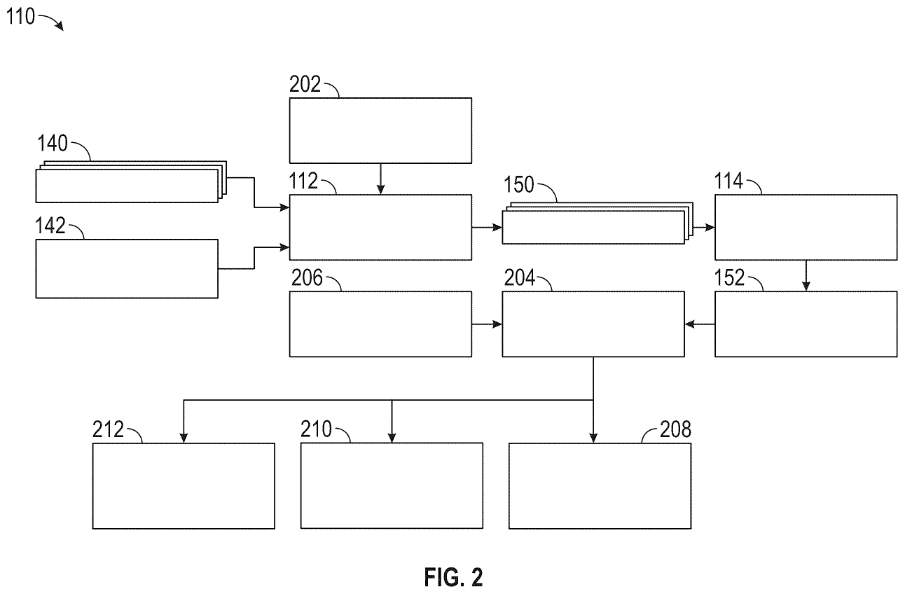

FIG. 2 illustrates a detailed flow diagram of a method of executing the first stage 110 of FIG. 1 according to one or more embodiments. The first stage 110 includes generating the feature file 150 and the transactional level I/O model 152. The system 100 begins with the input of doors requirements 140 and other requirements 142 into the feature file generator 112. The feature file generator 112 processes these requirements, applying scenario coverage constraints 202, such as only border and middle cases, to generate the feature file 150.

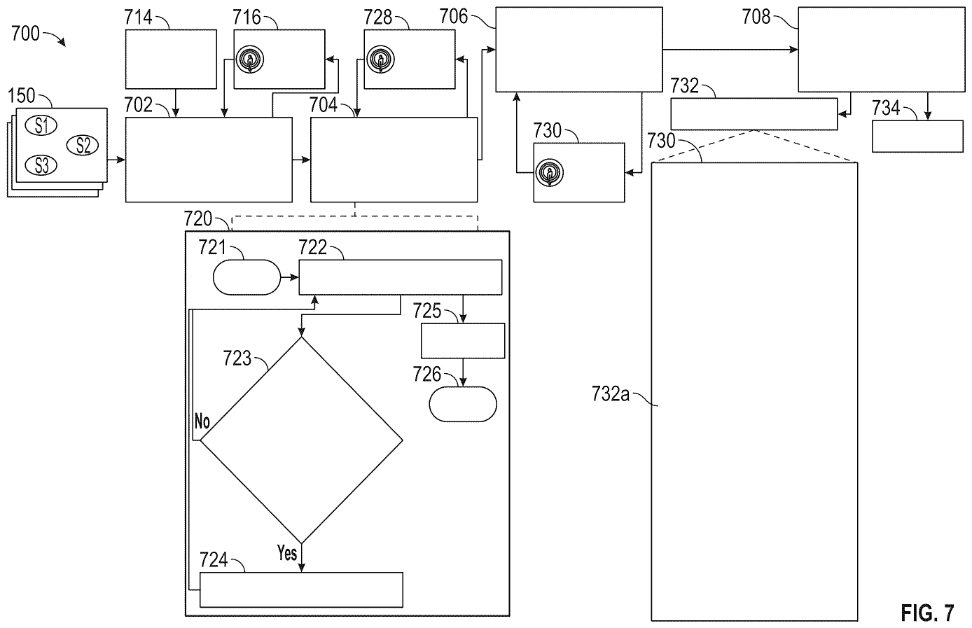

The generated feature file 150 is then fed into the transactional level (I/O) model builder 114, which constructs the transactional level I/O model 152. The transactional level (I/O) model builder 114 can also generate a report (see FIG. 7). The transactional level I/O model 152 captures the detailed I/O interactions and dependencies within the system of the vehicle to be tested, ensuring accurate representation of system interfaces.

Next, the transactional level I/O model 152 is processed by the user specific visualizer 204 to generate a user-specific visualization of the transactional level I/O model. The user specific visualizer 204 generates user-specific visualizations based on the user type or view requested 206. These visualizations can include a system level agent interaction model 212, a system level data & control flow model 210, and a component level designer model view 208, tailored to the needs of different stakeholders.

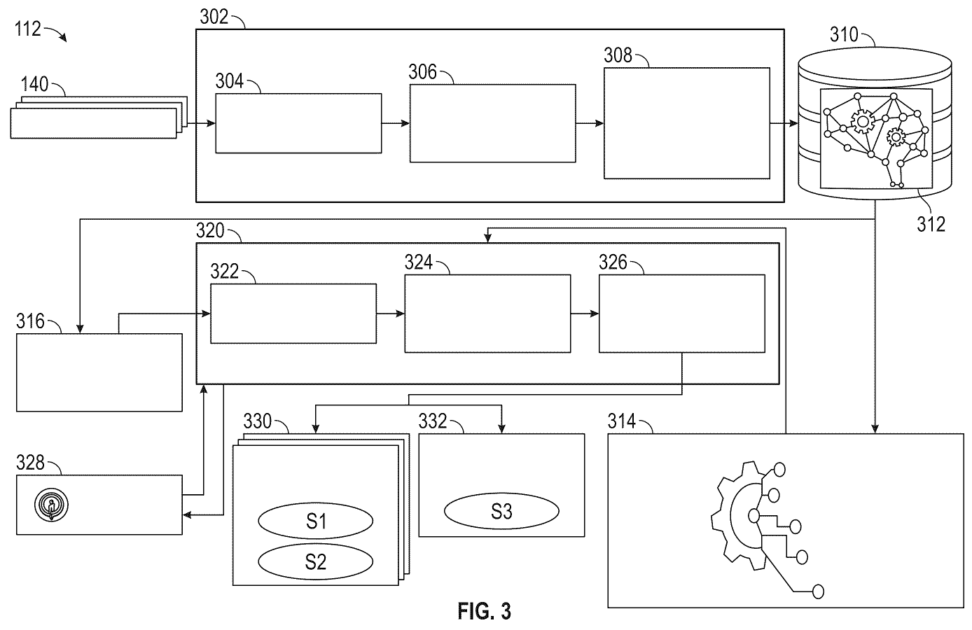

FIG. 3 illustrates a flow diagram of the execution of the feature file generator 112 of FIG. 2 according to one or more embodiments. More particularly, FIG. 3 illustrates the various stages and components involved in converting requirements into feature files and generating use cases and scenarios. The process, which includes a first LLM powered agent 302 and a second LLM powered agent 320, begins with the input of doors requirements 140 into the system.

The first LLM powered agent 302 performs requirements type specific chunking 304, where the doors requirements 140 are divided into specific chunks based on their type. The first LLM powered agent 302 then performs tables and diagrams interpretation and chunking 306, where tables and diagrams within the doors requirements 140 are interpreted and chunked accordingly. Next, the first LLM powered agent 302 performs dependency and interaction-based requirements linking 308, which links and summarizes the doors requirements 140 based on their dependencies and interactions. This results in an embedding model 312, which can be stored in a data store 310.

Next, using the embedding model 312, the system processes and groups the requirements and for each of the requirements groups of the doors requirements 140 at block 316 using the second LLM powered agent 320. Particularly, the second LLM powered agent 320 generates use cases and I/O extractions 322, which involves identifying and extracting use cases and input/output interactions from the doors requirements 140. The second LLM powered agent 320 then generates and refines expected outputs and build scenarios 324 and generates the feature file 150 at block 326. The second LLM powered agent 320 can use prompt engineering 314 as described herein. The second LLM powered agent 320 incorporates a human-in-the-loop phase 328 to ensure accuracy and completeness, enabling a prompt engineer or other user to participate in prompt generation and refinement for generating the feature file 150. According to one or more embodiments, the feature file 150 is a behavior-driven development (BDD) feature file for every level of the hierarchy, ensuring that the generated feature file 150 is comprehensive and detailed.

The feature file 150 can be output as feature file components 330 and feature file systems 332, each containing various scenarios (e.g., Scenario1 (S1), Scenario2 (S2), Scenario3 (S3)) that describe the desired behavior of the component or system, respectively, in plain language. These feature files (e.g., feature file components 330 and feature file systems 332) serve as a bridge between high-level requirements (e.g., doors requirements 140) and the actual test cases used to verify those requirements, facilitating automated test generation and validation.

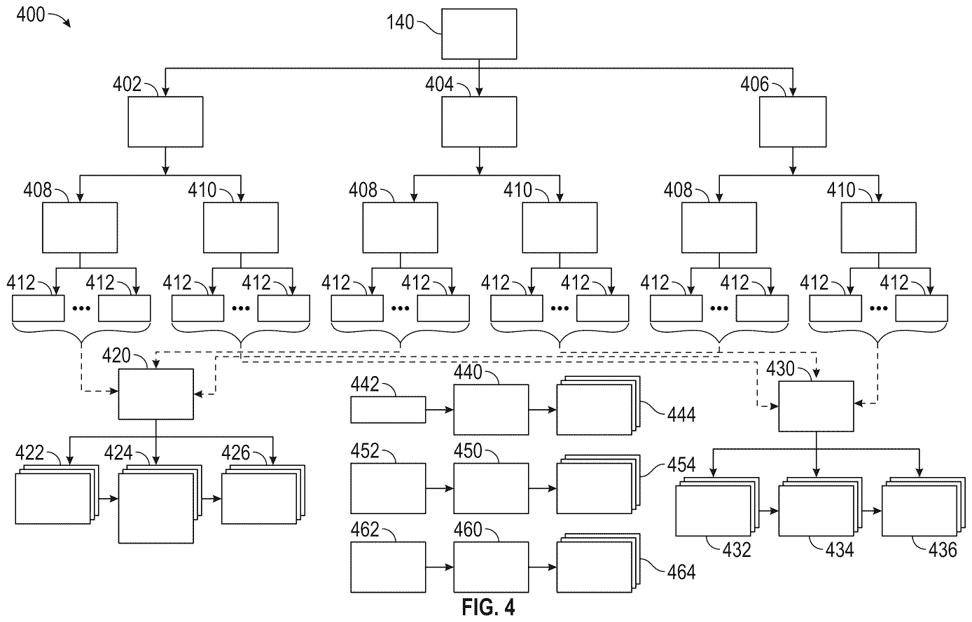

FIG. 4 illustrates a flow diagram of a method 400 for chunking and categorizing requirements to generate feature files and models according to one or more embodiments. That is, the method 400 depicts the operations that are executed when performing requirements type specific chunking 304 and performs tables and diagrams interpretation and chunking 306 of FIG. 3. The method 400 begins with the input of the doors requirements 140, which are divided into system requirements 402, sub system requirements 404, and components requirements 406. Each of these categories is further divided into functional requirements 408 and non-functional requirements 410. Each of the functional requirements 408 and the non-functional requirements 410, are further broken down into individual requirements 412 (e.g., Req sf 1 . . . Req sf n, Req snf 1 . . . Req snf n, Req ssf 1 . . . Req ssf n, Req ssnf 1 . . . Req ssnf n, Req cf 1 . . . Req cf n; Req cnf 1 . . . Req cnf n) where “sf” indicates system functional requirement, “snf” indicates system non-functional requirement, “ssf” indicates sub system functional requirement, “ssnf” indicates sub system non-functional requirement, “cf” indicates components functional requirement, and “cnf” indicates component non-functional requirement.

The individual requirements 412 undergo chunking, which can include one or more of semantic chunking 420, sentence chunking 430, temporal chunking 440, spatial chunking 450, and/or visual or image-based chunking 460. The semantic chunking 420 organizes the individual requirements 412 into system functional requirements chunks 422, sub system functional requirements chunks 424, and component functional requirements chunks 426. The sentence chunking 430 generates system non-functional requirements chunks 432, sub system non-functional requirements chunks 434, and component non-functional requirements chunks 436.

Temporal chunking 440 processes safety requirements 442 into safety requirement chunks 444. Spatial chunking 450 processes UI/UX design requirements 452 into UI/UK requirement chunks 454. Visual or image-based chunking 460 is applied to tables & images 462, resulting in tables & image chunks 464.

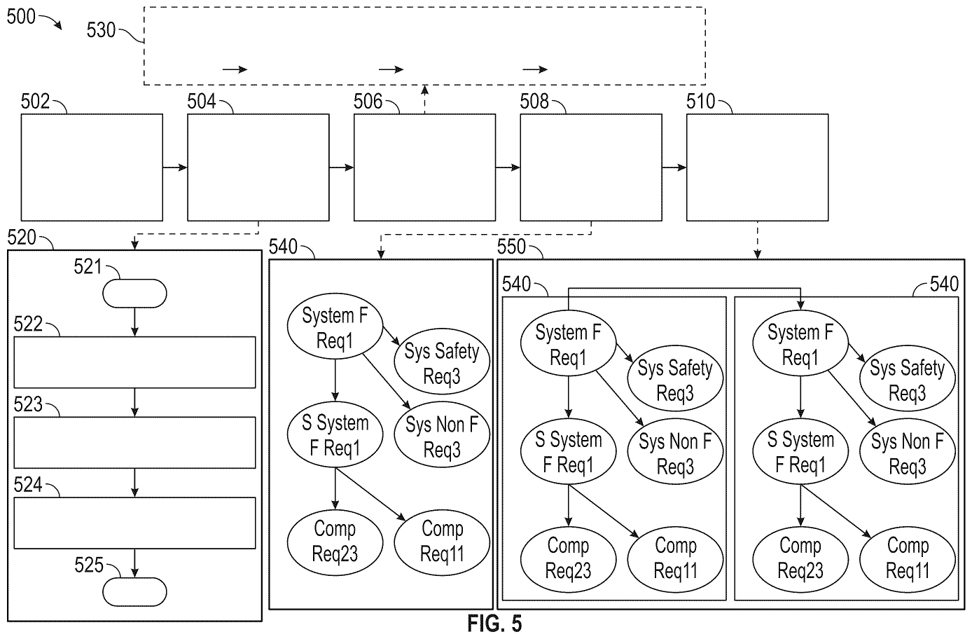

FIG. 5 illustrates a detailed flow diagram of a method 500 for grouping and linking requirements to build an ontology multigraph for comprehensive test case generation. That is, the method 500 depicts the operations that are executed when performing dependency and interaction-based requirements linking 308 of FIG. 3.

The method 500 begins with the input of requirements chunks 502 (e.g., one or more of the system functional requirements chunks 422, the sub system functional requirements chunks 424, the component functional requirements chunks 426, the system non-functional requirements chunks 432, the sub system non-functional requirements chunks 434, and/or the component non-functional requirements chunks 436), which are grouped at hierarchy levels in operation 504. This grouping ensures that requirements chunks are organized systematically, facilitating subsequent processing.

The grouping at operation 504 is performed using the sub-method 520 for identifying critical terms and calculating similarity scores, which starts at operation 521. At operation 522, for all the system requirements, LLM-based terms are identified. At operation 523, a terms-based LLM powered similarity calculation is performed at the levels of the hierarchy. At operation 524, threshold based terms based grouping is performed, and the sub-method 520 terminates at block 525 such that the method 500 proceeds with operation 506. This ensures that similar requirements are grouped together, enhancing the accuracy and consistency of the generated models.

In operation 506, the grouped requirements chunks are linked based on their relationship types. This linking process identifies dependencies and interactions between different requirements, creating a cohesive network of related requirements. According to one or more embodiments, operation 506 performs use case/requirements extraction 530 at the system and component level (e.g., use case→multiple features→multiple system→multiple components). operation 508 involves building an ontology multigraph 540 for the group of requirement chunks. This multigraph represents the relationships and interactions between the grouped requirements chunks in a structured and visual format. This includes identifying how system requirements meet design requirements, how component requirements are satisfied by system requirements, and how non-functional requirements are dependent on functional requirements. The visualization also highlights mutually exclusive requirements, ensuring that potential conflicts and dependencies are clearly identified.

The method 500 continues with operation 510, where a global ontology multigraph 550 is built by connecting the individual ontology multigraphs 540. The global ontology multigraph 550 provides a comprehensive view of the requirements and their interconnections, ensuring that the interactions and dependencies are accounted for.

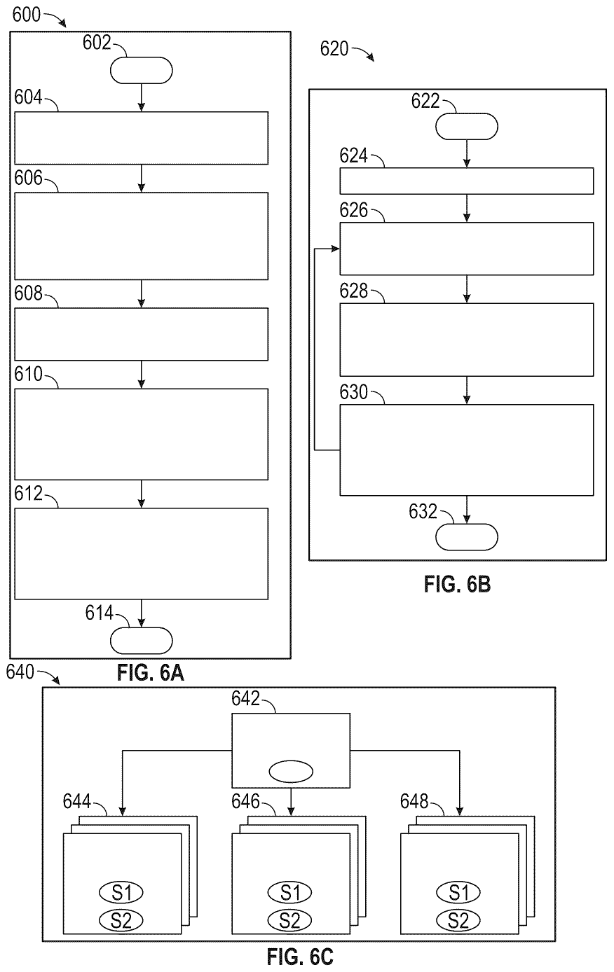

FIG. 6A illustrates a flow diagram of a method 600 for identifying actors/agents, corresponding I/O messages/events, and creating tags to annotate in the feature file 150 according to one or more embodiments. That is, the method 600 depicts the operations that are executed when generating use cases and I/O extractions 322. The method 600 begins at operation 602 and proceeds to operation 604, which defines the system, subsystem, or component requirements (Sys/Sys/Comp-Reqs).

At operation 606, actors/agents and their corresponding I/O messages/events are identified and tags are created to annotate in the feature file 150. Next, in operation 608, any preconditions, postconditions, and operational conditions associated with the use cases are identified and extracted. In operation 610, a basic flow use case scenario is built with respective outputs for given inputs and expected results. This operation involves creating a straightforward scenario that outlines the expected behavior of the system under normal conditions. Following this, in operation 612, an alternate or exception flow use case scenarios is built with expected outputs for given inputs. This operation addresses potential variations and exceptions in the system's behavior, ensuring comprehensive coverage of different possible scenarios. The method 600 concludes at step 614.

FIG. 6B illustrates a flow diagram of a method 620 for linking inputs and outputs to build a global system and create tags, ensuring comprehensive and consistent test case generation. That is, the method 620 depicts the operations that are executed when generating and refining expected outputs and build scenarios 324 of FIG. 3. The process begins at operation 622, and in operation 624, the system iterates through all use case scenarios using the following operations. At operation 626, a similarity score is calculated for each pair of use cases with respect to input/output. At operation 628, the inputs and outputs are linked to build a global system and create tags. In operation 630, any broken connections are identified and global embeddings or user inputs are used to generate missing expected outputs. The process concludes at step 632.

FIG. 6C illustrates a block diagram 640 of the organization and categorization of feature files (e.g., the feature file 150) into different hierarchical levels, each containing various scenarios, according to one or more embodiments. The block diagram 640 shows how feature files are systematically categorized to ensure comprehensive test case generation. At the top level, the feature file system 642 is depicted, which includes Scenario3. This represents the highest level of the system's feature files, encompassing broad scenarios that cover the overall system behavior. Below the feature file system 642 are multiple categories of feature files, including feature file component 644, feature file safety 646, and feature file sub system 648. Feature File Component 644 includes Scenario1 and Scenario2 and represents the feature files at the component level, detailing the behavior and interactions of individual components within the system. Feature File Safety 646 also includes Scenario1 and Scenario2 and focuses on safety-related feature files, ensuring that safety requirements and scenarios are thoroughly documented and tested. Feature file sub system 648 also includes Scenario1 and Scenario2 and represents the feature files at the subsystem level, detailing the behavior and interactions of subsystems within the overall system. Each category of feature files is associated with specific tags (e.g., Tag1, Tag2, Tag3) that help in organizing and retrieving the relevant scenarios. These tags ensure that the feature files are easily accessible and can be efficiently used for generating test cases.

FIG. 7 illustrates a flow diagram of a method 700 for generating the transactional level I/O model 152 from feature files and scenarios according to one or more embodiments. That is, the method 700 depicts the operations that are executed by the transactional level (I/O) model builder 114, ensuring consistency and completeness across various hierarchical levels. The method 700 begins at operation 702 with the input of the feature file 150, which contains multiple scenarios.

More particularly, at operation 702, key I/O terms extraction is performed from the scenarios in the feature file 150 at the hierarchical levels, utilizing a data dictionary 714. This operation can include a human-in-the-loop phase 716, where human intervention can be used to ensure the accuracy and relevance of the extracted terms.

Next, the method 700 performs operation 704, which includes performing a consistency check across scenarios at various levels of the hierarchy. The operation 704 can include a sub-method 720 which starts at operation 721 then proceeds to operation 722 which begins an iterative loop of each I/O interface. At operation 723, it is determined whether input and output names are the same and if any output interfaces are the same in two different blocks of the same level. If inconsistencies are found at operation 723, operation 724 lists the inconsistencies and iterates via operations 722 and 723. Once the iterative process completes, at operation 725, the inconsistencies in the list can be corrected, and the sub-method 720 terminates at operation 726. This process ensures that the I/O interfaces are accurately represented. This operation can include a human-in-the-loop phase 728, where human intervention can be implemented as described herein.

After the consistency check at operation 704, the method 700 proceeds to operation 706, where component level I/O interfaces are clustered/grouped. This operation can include another human-in-the-loop phase 730 to ensure the accuracy of the clustering process.

Finally, the method 700 proceeds to operation 708, which includes building the transactional level I/O model 152 by interconnecting I/O of hierarchical levels. This can be performed by using unified modeling language (UML) diagrams or message sequence charts (MSC). At operation 708, a transactional model JSON file 732 and a report 734 are generated. The transactional model JSON file 732 is an example of the transactional level I/O model 152. The report 734 summarizes the findings and ensures that the transactional level I/O model 152 is complete and consistent. According to one or more embodiments, the report 734 provides a detailed representation of the I/O interactions and dependencies within the system. This structured approach enhances the accuracy and completeness of the generated models, namely the transactional level I/O model 152, facilitating efficient and effective test case generation and validation.

The following pseudo code 732a is a partial example of code included in the transactional model JSON file 732:
“system_block”: {
   “name”: “ExampleSystemBlock”,
   “description”: “A sample system block with input and output interfaces”,
   “inputs”: [
   {
      “name”: “Input1”,
      “type”: “digital”,
      “description”: “Digital input signal”,
   },
   {
      “name”: “Input2”,
      “type”: “analog”,
      “description”: “Analog input signal”,
   }
   ],
   “outputs”: [
   {
   “name:” Output 1,”

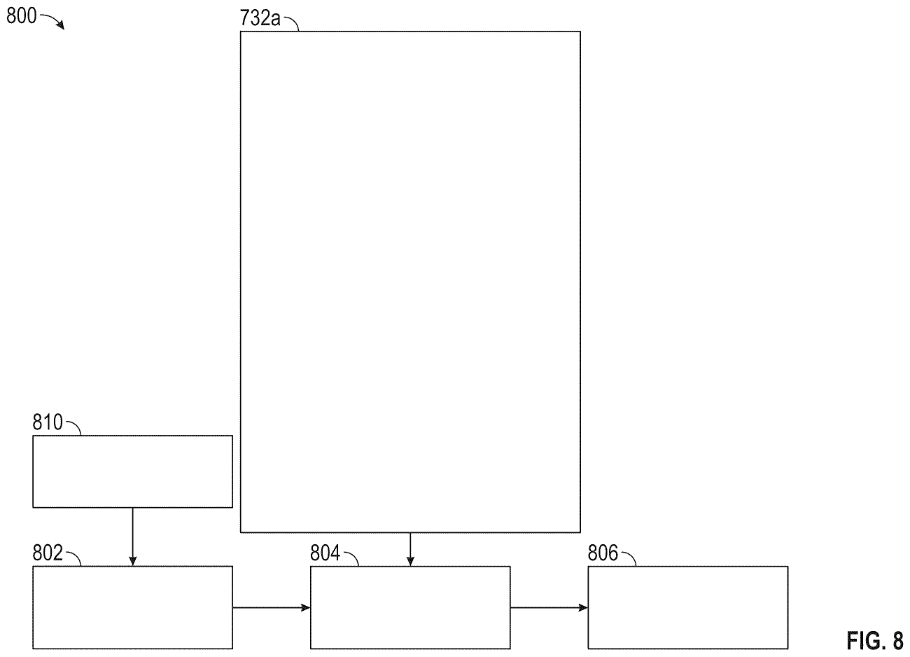

FIG. 8 illustrates a flow diagram of a method 800 for generating user-specific visualizations of a transactional level I/O model based on user requests according to one or more embodiments. That is, the method 800 depicts the operations that are executed when performing the user specific visualizer 204 of FIG. 2.

The method 800 begins at operation 802 by reading a user request 810. This user request includes the user type/view requested, which specifies the type of view or visualization the user desires.

Once the user request is read, the method 800 proceeds operation 804, which filters and abstracts the transactional model JSON file 732 (e.g., the pseudo code 732a) for the requested view. This step involves using tags to filter and abstract the relevant information from the transactional model JSON file 732, ensuring that data for the requested view is included.

After filtering and abstracting the transactional model JSON file, operation 806 is performed, which completes the transactional model JSON file 732 and builds the appropriate diagram view according to the user's request (e.g., user type/view requested). The operation 806 involves finalizing the transactional model JSON file 732 and generating the corresponding block diagram that visually represents the transactional level I/O model 152 according to the user's specifications.

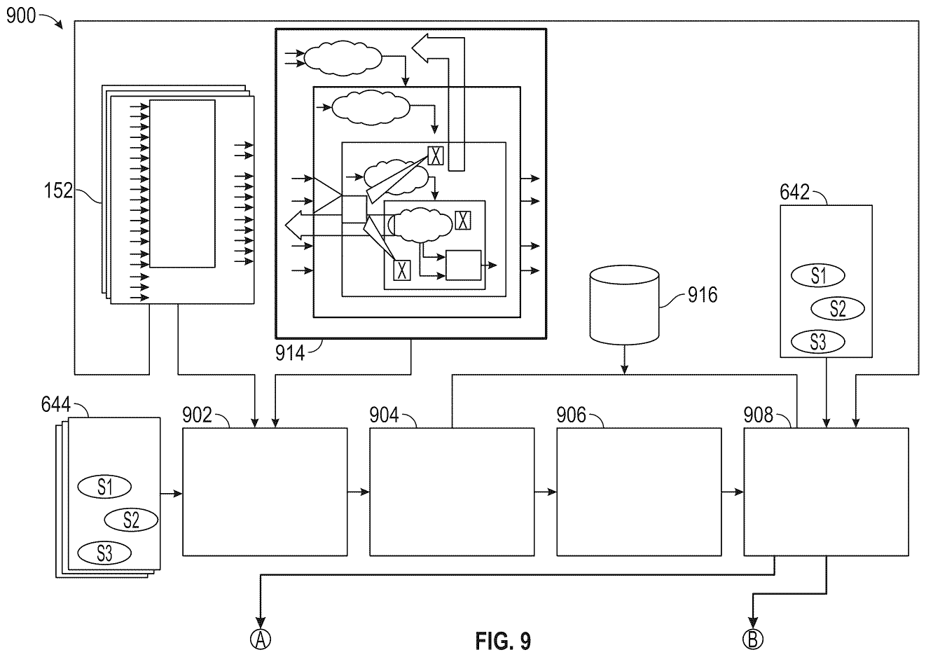

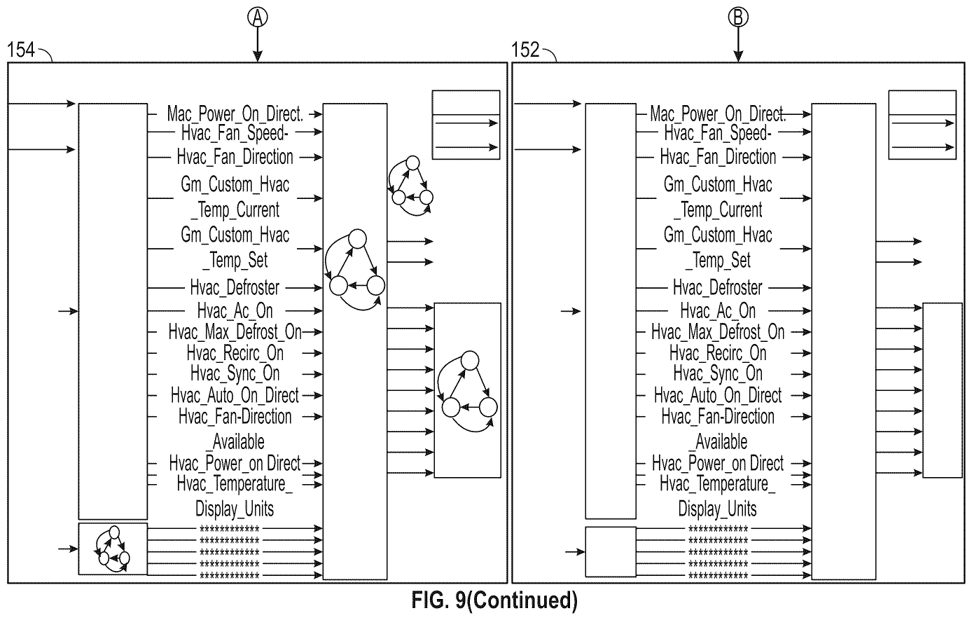

Turning now to FIGS. 9-11B automatically generating and updating behavioral models using LLMs from textual artifacts and I/O interface models at various levels is described in more detail. More particularly, the features and functionality of the second stage 120 of FIG. 1 is now described, including the operation of the transactional behaviors and I/O dependency model builder 122 of FIG. 1. The transactional behaviors and I/O dependency model builder 122 generates the behavioral model 154 using the transactional level I/O model 152, the feature file 150, and other information, such as user stories, user issues, and other textual artifacts. According to one or more embodiments, generating the behavioral model 154 includes using textual artifacts and the transactional level I/O model 152 at various levels using LLMs, incrementally completing behaviors using a set of engineered prompts for the LLMs, and analyzing logical expression-based gaps, which are filled with appropriate missing expressions and transitions.

Turning now to FIG. 9, a detailed flow diagram of a method 900 of executing the second stage 120 of FIG. 1 is described according to one or more embodiments. The second stage 120 includes generating behavioral models using LLMs from textual artifacts and transactional level I/O models at various levels. The method 900 employs a structured approach to incrementally build and refine behavioral models, ensuring completeness and accuracy.

The method 900 begins at operation 902 with reading feature file components (e.g., the feature file component 644), corresponding I/O models (e.g., transactional level I/O model 152), and hierarchical levels 914. These feature file components, such as feature file component 644, contain various scenarios (Scenario1, Scenario2, Scenario3). The system systematically gathers the information from these files/sources to ensure a comprehensive understanding of the components and their interactions.

Once the feature file feature file component 644 and transactional level I/O model 152 are read, the method 900 proceeds to operation 904, where behaviors are incrementally built from a base scenario to multiple (e.g., all) scenarios using a modeling language. This step ensures that behaviors are developed in a structured manner, starting from the simplest (base) scenario and progressively incorporating more complex interactions until many or substantially all scenarios are incorporated. By incrementally building the behaviors, the system can systematically address each scenario, ensuring that many possible conditions and interactions are considered.

At operation 906, the method 900 includes identifying and highlighting gaps in the conditions and decision expressions within the behaviors. This involves analyzing the existing behaviors to detect any missing conditions or transitions that could lead to incomplete or inconsistent models. The system adds missing scenarios to fill these gaps, ensuring that the behavioral model is both complete and accurate. This gap analysis and filling process is useful for creating a robust behavioral model that accurately represents the system's intended functionality.

Subsequently, at operation 908, the method 900 includes building system-level behaviors and analyzing them in conjunction with component behaviors. This operation involves integrating the component-level behaviors into a cohesive system-level model, which represents the behavioral model 154, ensuring that the interactions between different components are accurately represented. The operation 908 further includes adding any missing scenarios as needed to ensure that the system-level behaviors are comprehensive and consistent with the component-level behaviors. This integration process helps in identifying potential issues in the interaction sequences and ensures that the overall system behavior is accurately captured.

The feature file component 644 and the transactional level I/O model 152 plays a role in supporting the behavior generation process at operation 908. These files/models are used to ensure that the input/output interactions are accurately represented, providing a detailed view of the data flow and control signals between various components.

At operations 904, 906, and/or 908, a prompt library 916 can be used for periodic/event-based prompt engineering, guiding the LLMs in generating and updating the build process. This prompt library provides the appropriate prompts to the LLMs, ensuring that the generated models are accurate and relevant.

The behavioral model 154 can be generated as state diagrams for example. This visualization helps in understanding the dynamic aspects of the system and identifying potential issues in the interaction sequences. The state diagrams provide a clear view of the different states and transitions within the system. Such visualizations enhance the clarity and usability of the generated models, making it easier for stakeholders to understand and validate the system's behavior.

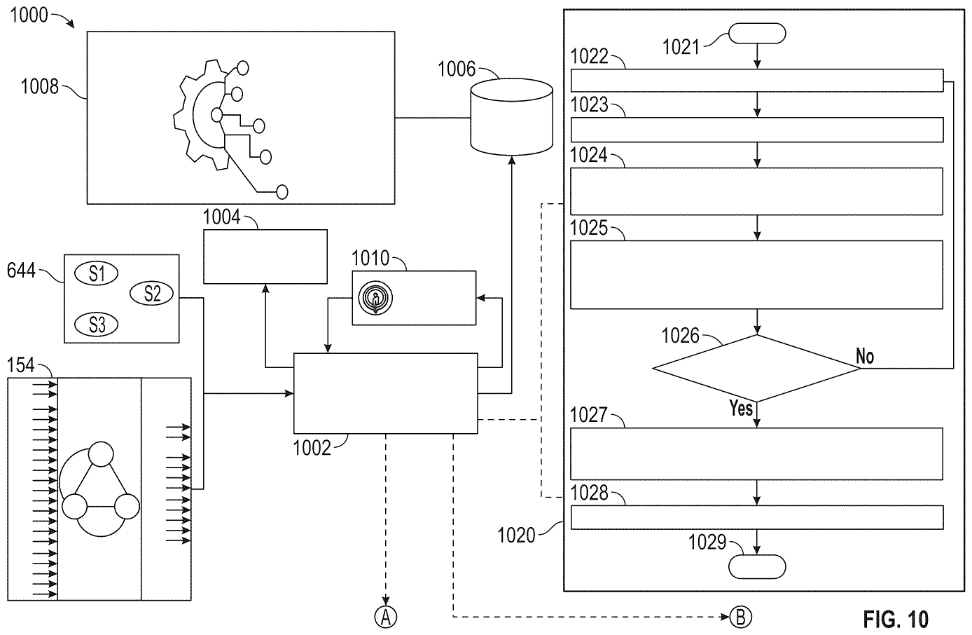

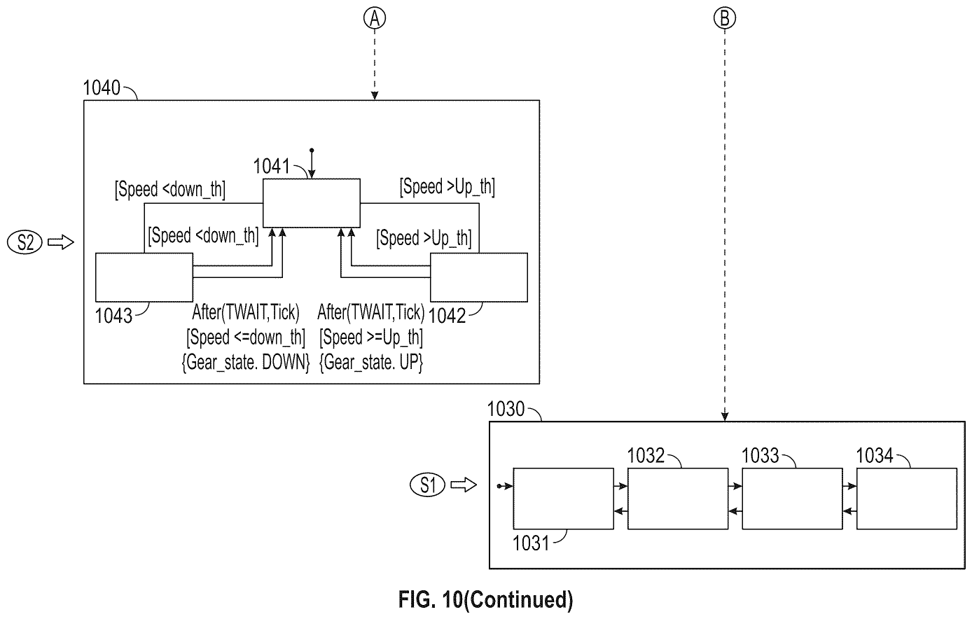

FIG. 10 illustrates a flow diagram of a method 1000 for incrementally building behaviors according to one or more embodiments. That is, the method 1000 depicts operations that are executed when performing operation 904 of FIG. 9.

The method 1000 begins at an LLM powered agent/state identifier and behavioral model builder 1002. The method 1000 utilizes the LLM-powered agent/state identification and behavioral model builder 1002 to extract possible states and communicating agents from the scenarios. This component identifies the elements used to build the behavioral models (e.g., behavioral model 154). The LLM powered agent/state identifier and behavioral model builder 1002 receives a model type 1004 and prompts from a prompt library 1006. The prompt library 1006 is used for periodic/event-based prompt engineering 1008. The prompt library 1006 provides customized prompts to guide the LLM powered agent/state identifier and behavioral model builder 1002 in converting scenarios into specified behavioral model types, such as finite state machines (FSM) or message sequence charts (MSC), which are defined by the model type 1004. The prompt engineering process ensures that the LLM receives the appropriate instructions to generate accurate and relevant models (e.g., behavioral model 154). The LLM powered agent/state identifier and behavioral model builder 1002 also implements a human-in-the-loop phase 1010 to allow for manual updates and checks to ensure the model's accuracy and completeness.

The flowchart of a sub-method 1020 on the right side of FIG. 10 details the step-by-step process of generating and updating the behavioral models (e.g., behavioral model 154). The sub-method 1020 starts at operation 1021, and proceeds to operation 1022 where a scenario (Scenario_i) is read. At operation 1023, the possible states and communicating agents are extracted from the scenario read at operation 1021. At operation 1024, the LLM is called with a customized prompt to convert the scenario into the specified behavioral model type. At operation 1025, the LLM is called with a customized prompt to create or to add to the existing behavioral model with a focus to complete the previous scenario or partial model.

At operation 1026, it is determined whether an end of scenario list has been reached. If not (operation 1026 “No”), the sub-method 1020 iterates by returning to operation 1022 and reading a next scenario. If so (operation 1026 “Yes”), the sub-method 1020 proceeds to operation 1027. At operation 1027, once the scenarios are processed, the LLM is called to check if the behavioral model is complete and ask for completion feedback. At operation 1028, the human-in-the-loop phase 1010 is implemented to enable for manual updates and checks to ensure the model's accuracy and completeness. The sub-method 1020 ends at block 1029.

The method 1000 generates visual representations of the behavioral models, such as state diagrams and message sequence charts. For example, Scenario1 and Scenario2 are depicted with their respective state diagrams 1030, 1040, illustrating the different states and transitions within the system to be tested. These visualizations help in understanding the dynamic aspects of the system and identifying potential issues in the interaction sequences.

For example, the diagram 1030 includes a first entry state 1031 (gear=1), a second entry state 1032 (gear=2), a third entry state 1033 (gear=3), and a fourth entry state 1034 (gear=4). The right pointing arrows between states 1031-1034 represent up shifts (e.g., from gear 1 to gear 2), while the left pointing arrows between states 1031-1034 represent down shifts (e.g., from gear 2 to gear 1).

The diagram 1040 includes a steady state 1041, an upshifting state 1042 (e.g., shifting from gear 1 to gear 2), and a downshifting state 1043 (e.g., shifting from gear 2 to gear 1). The arrows between the states 1041-1043 represent transitions between the states and represent various conditions under which such transitions occur (e.g., downshifting when the speed is less than a downshifting threshold).

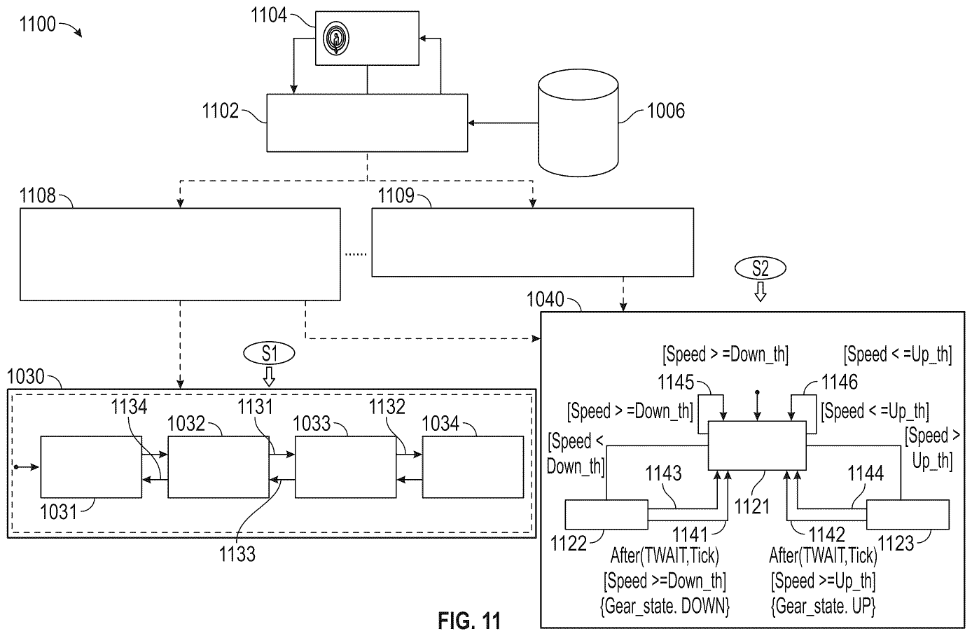

FIG. 11 illustrates a block diagram of a system 1100 for identifying gaps in conditions and decisions expressions and adding missing scenarios according to one or more embodiments. That is, the system 1100 depicts operations that are executed when performing operation 906 of FIG. 9. The system 1100 employs a structured approach to identify and address gaps in conditions and decision expressions within scenarios, ensuring comprehensive and accurate behavioral models.

Central to the system 1100 is a prompt engineering module 1102, which performs chain of thoughts-hierarchical queries. The system 1100 employs hierarchical queries to systematically identify gaps in the conditions and decision expressions within the scenarios. For example, the prompt engineering module 1102 guides the LLMs to analyze the scenarios and identify any missing transitions or conditions.

The prompt engineering module 1102, is supported by a prompt library 1006 for periodic/event-based prompt engineering as described herein. The prompt library 1006 provides customized prompts to guide the LLMs in generating and refining the behavioral models. The prompt engineering module 1102 also includes a human-in-the-loop phase 1104, allowing for manual updates and checks to ensure the model's accuracy and completeness.

In this example, two scenarios are present: Scenario1 and Scenario2.

At operation 1108, for Scenario1 and Scenario2, an option for handling the occurrence of two or more inputs/conditions at the same time. This addresses the question: “What if two or more inputs/conditions happen at the same time?” This involves providing options to handle such situations as per the design language. The state diagram 1030 illustrates the different states 1031-1034 and transitions for Scenario1. As described herein, each state 1031-1034 is associated with specific gear states and transitions, such as up shifts and down shifts. If two up shifts 1131, 1132 occur at the same time (or similarly if two down shifts 1133, 1134), it can be determined which to implement, or which to implement first. Similarly, for Scenario2, if two transitions 1141, 1142 occur at the same time (or similarly if two down shifts 1143, 1144), it can be determined which to implement, or which to implement first.

At operation 1109, for Scenario2, missing transitions are added for any expression logical gaps. That is, the system 1100 focuses on identifying and addressing any expression logical gaps and adding missing transitions appropriately. The state diagram 1040 includes various states such as the ready_state (1121), downshifting (1122), and upshifting (1123). The diagram also highlights the conditions for transitions, such as speed thresholds (e.g., [Speed<=down_th] and [Speed>=up_th]) and the corresponding actions (e.g., gear_state: DOWN and gear_state: UP). The prompt engineering module 1102 identifies missing conditions 1145, 1146, such as [Speed<=down_th] and [Speed>=up_th] respectively.

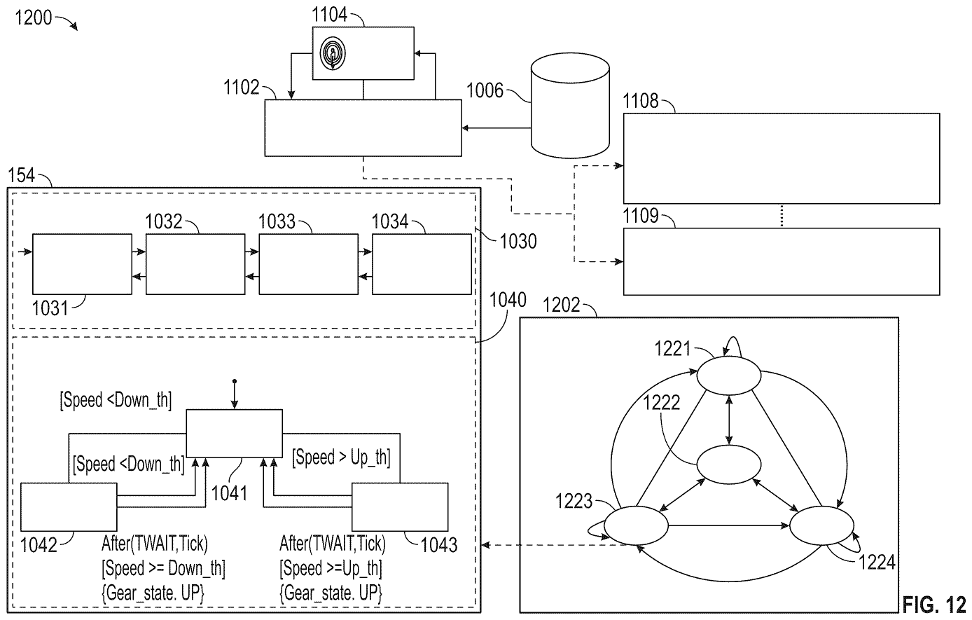

FIG. 12 illustrates a system 1200 for building system level behavioral models according to one or more embodiments. That is, the system 1200 depicts operations that are executed when performing operation 908 of FIG. 9. The system 1200 employs a structured approach to building system level behavioral models, ensuring comprehensive and accurate behavioral models.

In this example, the system level behavioral model is represented as the behavioral model 154, which incorporates the state diagrams 1030, 1040 described in reference to FIGS. 10 and 11.

The behavioral model 154 also incorporates a state diagram 1202, which depicts the gear states and transitions for a vehicle system. The diagram 1202 includes states, such as Gear=P (state 1221), Gear=N (state 1222), Gear=D (state 1223), and Gear=R (state 1224). Each state is associated with specific conditions and transitions, such as “Speed<5mph & P Shift” and “Brake & R Shift.” The diagram 1202 provides a clear view of the different states and transitions within the vehicle system, helping to identify potential issues in the interaction sequences.

What results is a comprehensive and robust behavioral model 154. By addressing gaps in conditions and decision expressions, integrating human-in-the-loop phases, and providing detailed visualizations, the system 1200 ensures that the generated models are complete, accurate, and consistent. This approach improves the efficiency, accuracy, and coverage of test case generation in vehicle development.

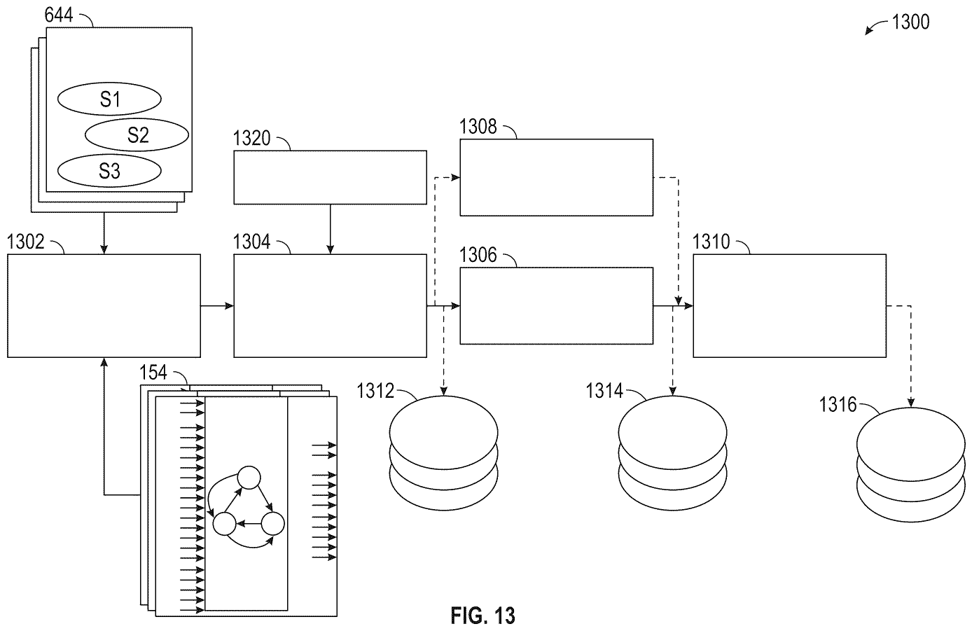

Turning now to FIGS. 13-17 automatically generating test cases, such as test cases 156, is described in more detail. More particularly, the features and functionality of the third stage 130 of FIG. 1 is now described, including the operation of the component level guided test case generator 132 and the synthesis system level test case generator 134 of FIG. 1.

Turning now to FIG. 13, a detailed flow diagram of a method 1300 of executing the third stage 130 of FIG. 1 is described according to one or more embodiments. The third stage 130 uses the behavioral model 154, the input dependency logic 146, and/or system feature file 148 to generate the test cases 156. According to one or more embodiments, generating the test cases 156 includes using textual artifacts and the behavioral model 154 to perform systematic, optimal, efficient, and improved test case coverage by generating component test cases, sub system test cases (also referred to as “system level test cases”), and system test cases (each of which is an example of the test cases 156).

The method 1300 begins with the input of a feature file component (e.g., feature file component 644), which includes various scenarios such as Scenario1, Scenario2, and Scenario3. At operation 1302, the component feature files and corresponding behavioral models (e.g., behavioral model 154) are read to gather the information used for test case generation. The behavioral models provide a detailed representation of the system's dynamic aspects, which are useful for generating accurate test cases.

Next, at operation 1304, test cases are generated for the given component feature files and models. This involves utilizing design details 1320, which may include design details, signals, and variable types, to account for the system's behavior when generating test cases. The output of this operation is a set of component-level test cases 1312, which are designed to validate the functionality of individual components of the system to be tested.

The method 1300 then moves to operation 1306, where system-level test cases are synthesized from the component-level test cases 1312. This synthesis ensures comprehensive test coverage by integrating the component-level test cases 1312 into a cohesive set of system-level test cases, such as system test cases 1314. The system test cases 1314 can optionally also be generated at operation 1308 from feature files (e.g., feature file 150) and behavioral models (e.g., behavioral model 154), similar to 1304 using the LLM ensuring that various possible interactions and scenarios are considered.

At operation 1310, safety test cases are generated for various safety scenarios at multiple hierarchical levels. This operation ensures that the system's safety requirements are thoroughly tested, resulting in a set of safety test cases 1316. The safety test cases 1316 are useful for validating the system's compliance with safety standards and regulations.

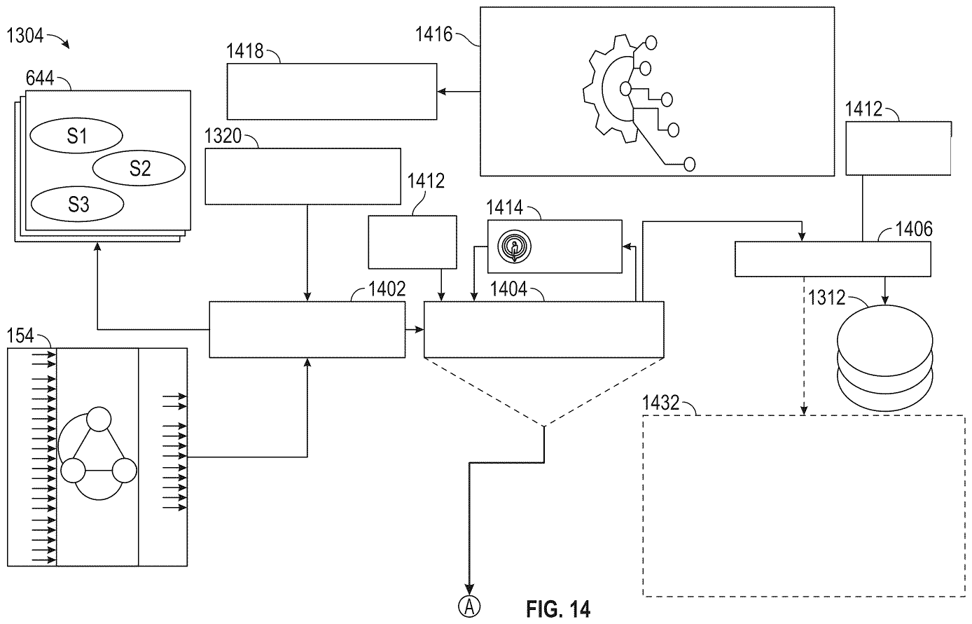

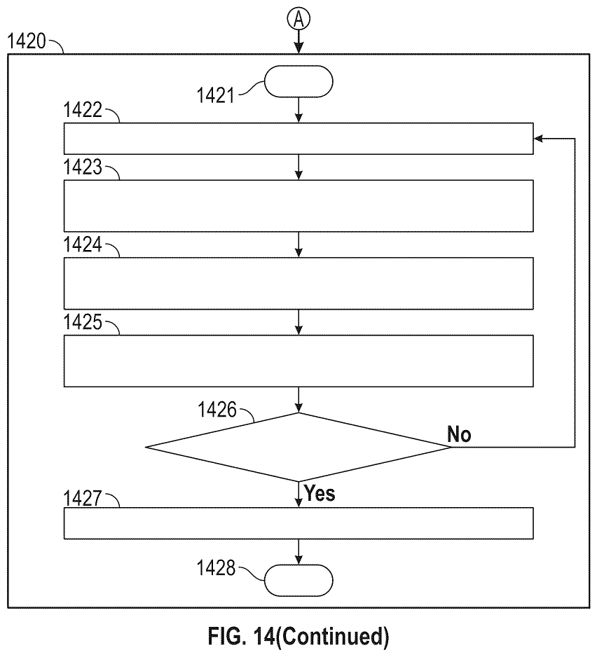

FIG. 14 illustrates a flow diagram of a method for generating component-level test cases 1312 according to one or more embodiments. That is, the method depicts the operations that are performed when the operation 1304 of FIG. 13 is executed.

The process begins with the input, at operation 1402, of a feature file 644, which contains multiple scenarios, and behavioral model 154, which may be a component behavioral model. Also input, at operation 1402, are the design details 1320.

The system initiates the test case generation process by calling the LLM to generate test cases at operation 1404. This involves iterating through the scenarios, user stories, issues, and models at operation 1402 to identify output signals or variables from each scenario, along with their data types and descriptions. The LLM is called with customized prompts, such as from prompt engineering 1416 (which may utilize instantiation of variable and equation solving prompts 1418) to generate a set of test cases. Coverage criteria 1412 can also be input at operation 1404 to define a desired coverage for the component test cases. Operation 1404 can also include performing a human-in-the-loop 1414.

Operation 1404 includes performance of a sub-method 1420 for generating test cases using the LLM. Particularly, sub-method 1420 outlines a process for generating and optimizing test cases using LLMs, ensuring that the generated test cases are comprehensive, accurate, and aligned with the system's requirements. The sub-method 1400 is an iterative process that iterates through each of the scenarios in a scenario list defined by the feature file 644. The sub-method 1400 starts at operation 1421 and proceeds to operation 1422, where a scenario or other relevant artifact is read, extracting the information from feature files, user stories, or issue verbatims to understand the context and requirements for the test cases. At operation 1423, the output signal is identified from the scenario and its data type and descriptions. At operation 1424 the LLM is called with a customized prompt to generate a set of test cases, designed to guide the LLM in creating test cases that include the expected output calculation steps, ensuring alignment with the system's requirements and expected outcomes. Following this, at operation 1425, the LLM is called again with a customized prompt to optimize the set of test cases, considering other scenarios and existing test cases to refine and enhance them, ensuring efficiency and comprehensiveness. The sub-method 1420 iterates through the scenario list, repeating the process for each scenario until the end of the list is reached, ensuring that all scenarios are considered and that the test cases are comprehensive and accurate. That is, at operation 1426, it is determined whether the scenario is the end of the scenario list, and if not (operation 1426 “No”), the sub-method 1420 returns to operation 1422 and iterates through for a next scenario. If so (operation 1426 “Yes”), the sub-method 1420 implements a human-in-the-loop 1427 to update and check the test cases. The human-in-the-loop 1427 provides an opportunity for human intervention to validate and refine the test cases, ensuring they meet the necessary standards and requirements Any missing coverage is identified, and targeted coverage prompts are generated to address these gaps, ensuring comprehensive coverage of the system's requirements and expected outcomes. The sub-method 1420 then ends at operation 1428.

The system also incorporates the coverage criteria 1412 to measure the coverage of the generated test cases at operation 1406 and are validated against the coverage criteria 1412. This can involve LLM calls or simulation-based coverage measurement tools at operation 1432 for various types of coverage, including state, transition, condition, decision, and modified condition/decision coverage (MC/DC). The system identifies any missing coverage and generates targeted coverage prompts to address these gaps and repeats at least portions of the operations at operation 1406.

The final output of the system is a set of component-level test cases 1312 that are comprehensive and optimized for coverage. The component-level test cases 1312 meet the standards due to their validation against the coverage criteria 1412 at operation 1406.

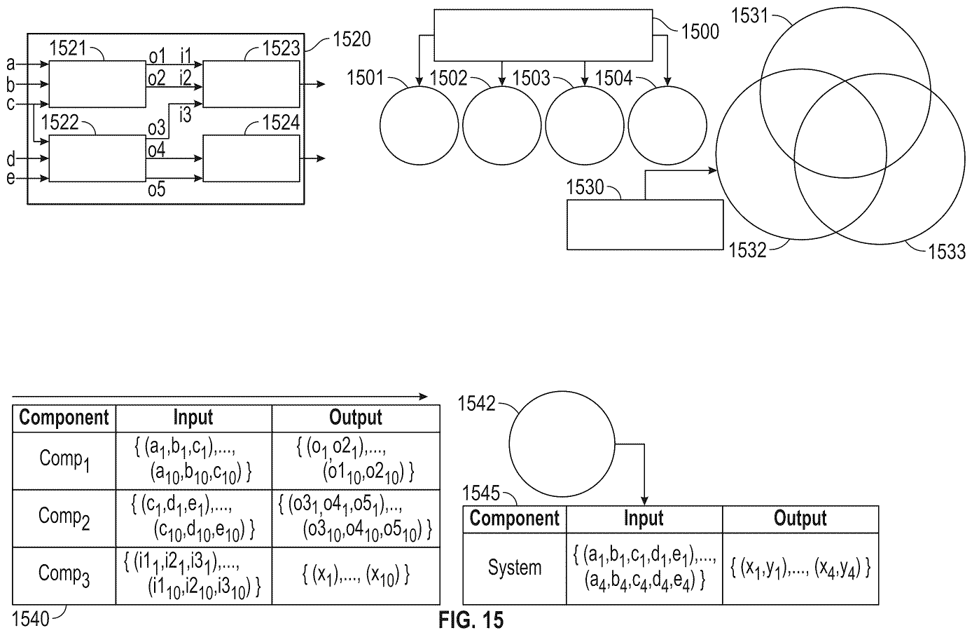

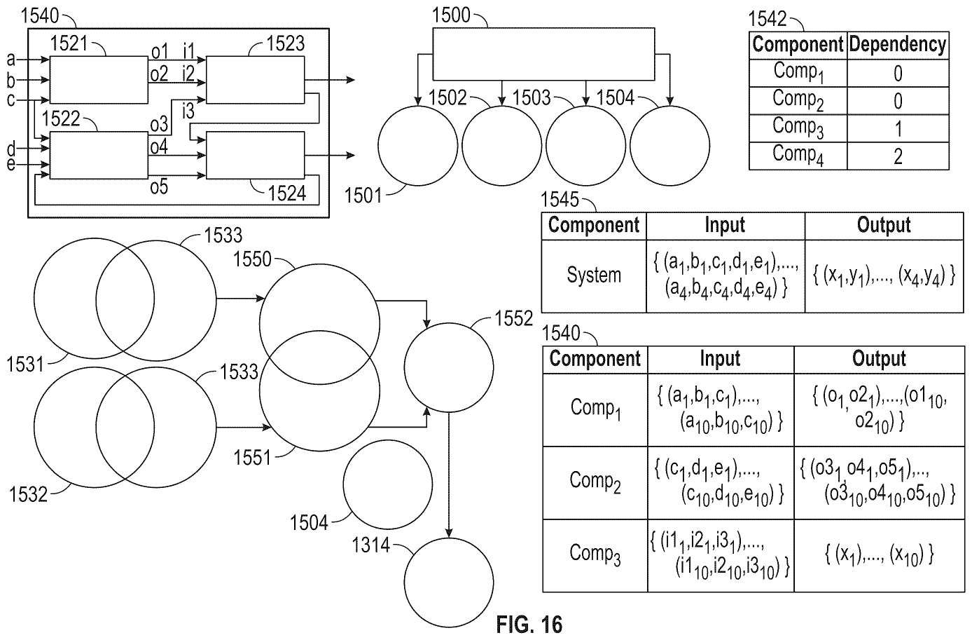

FIGS. 15 and 16 together illustrate a flow diagram of a method for generating a system test cases 1314 according to one or more embodiments. That is, the method depicts the operations that are performed when the operation 1306 and/or operation 1308 of FIG. 13 is executed. In particular, these figures depict operations for synthesizing system test cases from component test cases and/or for generating system test cases from component test cases.

The process begins with component level test case generation (operation 1500), which generates test cases 1501, 1502, 1503, 1504 respectively for component 1, component 2, component 3, and component 4. According to one or more embodiments, the component test case generation is performed at operation 1304 of FIG. 13.

The components (e.g., component 1, component 2, component 3, and component 4), have dependencies as shown in the dependency diagram 1520, which includes Component 1 1521, Component 2 1522, Component 3 1523, and Component 4 1524. Component 1 1521 and Component 2 1522 are connected to Component 3 1523, with outputs O1, O2, and O3 being compared with inputs i1, i2, and i3 to derive a system test case for these components. Understanding this dependency is useful for understanding how the outputs of one component serve as inputs to another, ensuring that the synthesized test cases accurately reflect the system's operational logic.

A system level test case synthesizer 1530 synthesizes outputs of the test cases 1501, 1502, 1503, and/or 1504. For example, the system level test case synthesizer 1530 synthesizes the outputs of test cases 1501, 1502, 1503, which are illustrated as a Venn diagram having circles 1531, 1532, 1533 corresponding to test cases 1501, 1502, 1503 respectively. As shown, outputs O1 corresponding to input I1, O2 corresponding to input I2, and O3 corresponding to input I3 are common among the test cases 1501, 1502, 1503. These inputs and outputs are depicted in table 1540 for each of Component 1 1521, Component 2 1522, and Component 3 1533, where these component test cases are restricted with the condition O1=i1, O2=i2, and O3=i3 such that a new test case is synthesized (operation 1542). Particularly, at operation 1542, a new test case for the combination of Component 1 1521, Component 2 1522, and Component 3 1533 is generated as a system test case shown in table 1545.

With reference to FIG. 16, a feedback dependency 1540 shows two feedback dependencies: a first feedback dependency between Component 3 1523 and Component 4 1524, and a second feedback dependency between Component 4 1524 and Component 2 1522. The dependencies are characterized in the table 1545. The system level test case synthesizer 1530 of FIG. 15 can synthesize the test cases 1501, 1503 and the test cases 1502, 1503, which are shown as separate Venn diagrams having circles 1531, 1533 in a first instance and 1532, 1533 in a second instance, as shown. In the case of synthesizing the test cases 1501, 1503, these test cases are restricted with the condition O1=i1 and O2=i2. In the case of synthesizing the test cases 1501, 1503, these test cases are restricted with the condition O3=3. Further synthesizing occurs with respect to partial test case 1550 and partial test case 1551, which share Condition 1 (C1)=Condition 2 (C2). A partial system test case 1552 is generated considering timing/input position rearrangement, and the test case 1504 is further integrated to generate system test cases 1314.

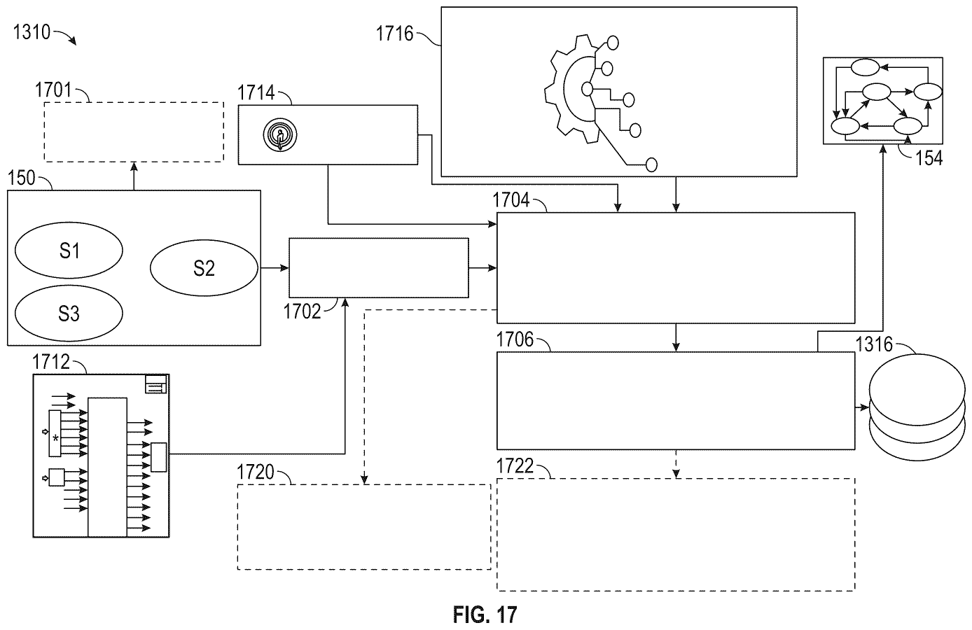

FIG. 17 presents a detailed flow diagram of a method for generating safety test cases according to one or more embodiments. That is, the method of FIG. 17 depicts the operations that are performed when the operation 1310 of FIG. 13 is executed. In this example, safety test cases 1316 relate to a lane keep assist safety feature 1701 within a vehicle system but is not so limited. This figure illustrates the systematic approach to ensuring that safety scenarios are thoroughly tested and validated, leveraging LLMs to enhance the process.

The process begins at operation 1702, with the input of a feature file 150 and a system structural model 1712, which provide the foundational data for defining safety scenarios and the overall system model. These inputs are useful for setting the context and parameters within which the safety test cases will be developed.

At operation 1704, LLM-powered functional element extraction is employed to identify functional elements 1720 useful for the safety feature. The functional elements 1720 include, for example, the identification of lane markings and the triggering of a steering nudge. The operation 1704 involves analyzing the safety scenario guided component and functionality dependency using tags, ensuring that relevant safety aspects are considered and accurately represented. As with other embodiments described herein, the operation 1704 can implement a human-in-the-loop 1714 and/or utilize prompts generated by prompt engineering 1716.

Once the functional elements are identified at operation 1704, the process proceeds to operation 1706, which includes identifying a functional scenario that exercises the safety situation and generates a test case for the scenario. This involves creating a specific scenario 1722. In this example, the specific scenario 1722 involves identifying lane markings and forcing the vehicle to approach the lane markings to trigger a steering nudge and checking if the nudge is within safety limits. The system uses behavioral models (e.g., behavioral model 154) to automatically generate these safety test cases, ensuring that they are comprehensive and aligned with the system's safety requirements.

The output of this process is a set of safety test cases 1316 that validate the system's compliance with safety standards and regulations. The safety test cases 1316 are designed to cover various safety scenarios at multiple hierarchical levels, ensuring that the vehicle system's safety features are thoroughly tested and validated. The use of LLMs in this process enhances the efficiency and accuracy of test case generation, reducing the manual effort required and ensuring that the test cases are both comprehensive and aligned with the system's operational and safety requirements.

One or more embodiments described herein provide various and significant improvements over traditional methods for generating test cases in vehicle development and consequently improve the reliability, efficiency, and overall operation of vehicles developed using such test cases.

Automation of Test Case Generation: One or more embodiments automates the generation of feature files and transactional models from requirements using LLMs with engineered prompts. This automation significantly reduces the manual effort required, leading to faster and more efficient test case generation.

Enhanced Accuracy and Consistency: By systematically converting legacy requirements into feature files and constructing hierarchical I/O models, one or more embodiments ensures completeness and consistency in connectivity. This reduces the likelihood of error and ensures that most if not all possible interactions are accurately represented.

Comprehensive Coverage: One or more embodiments provides a structured approach to categorizing and chunking various types of requirements, ensuring that they are organized and processed efficiently. This enhances the accuracy and completeness of the generated models and feature files, facilitating comprehensive test case generation and validation.

User-Specific Visualizations: One or more embodiments generates user-specific visualizations of the transactional level I/O model based on user requests. This ensures that different stakeholders can access tailored views of the model, enhancing the clarity and usability of the generated models.

Integration of Behavioral Models: One or more embodiments incorporates behaviors and I/O dependencies into the transactional model, resulting in a detailed behavioral model that captures the dynamic aspects of the system. This model is useful for understanding the vehicle system's operational logic and for identifying potential issues in the interaction sequences.

Iterative Consistency Checks: One or more embodiments includes iterative loops for consistency checking and human-in-the-loop phases to validate the accuracy and relevance of the extracted terms and clustered I/O interfaces. This ensures that the generated models are consistent and complete.

Efficient Resource Utilization: By automating the generation of test cases and reducing the time and effort required for manual analysis and validation, one or more embodiments allows engineers to focus on other tasks. This improves the overall quality of the testing process and optimizes resource utilization.

Reuse of Component-Level Test Cases: One or more embodiments synthesizes system-level test cases from component-level test cases, minimizing resource usage and ensuring comprehensive test coverage. This reuse approach enhances the efficiency of the test case generation process.

Automated Safety Test Case Generation: One or more embodiments automatically generates safety test cases and performs various coverage inspections without the need for simulation. This innovative approach significantly improves the efficiency, coverage, and quality of test cases, which in turn improves vehicles developed using those test cases.

Overall, the one or more embodiments described herein provides a more efficient, systematic, and accurate approach to generating test cases, addressing the limitations of traditional manual methods and enhancing the overall quality and reliability of vehicle systems.

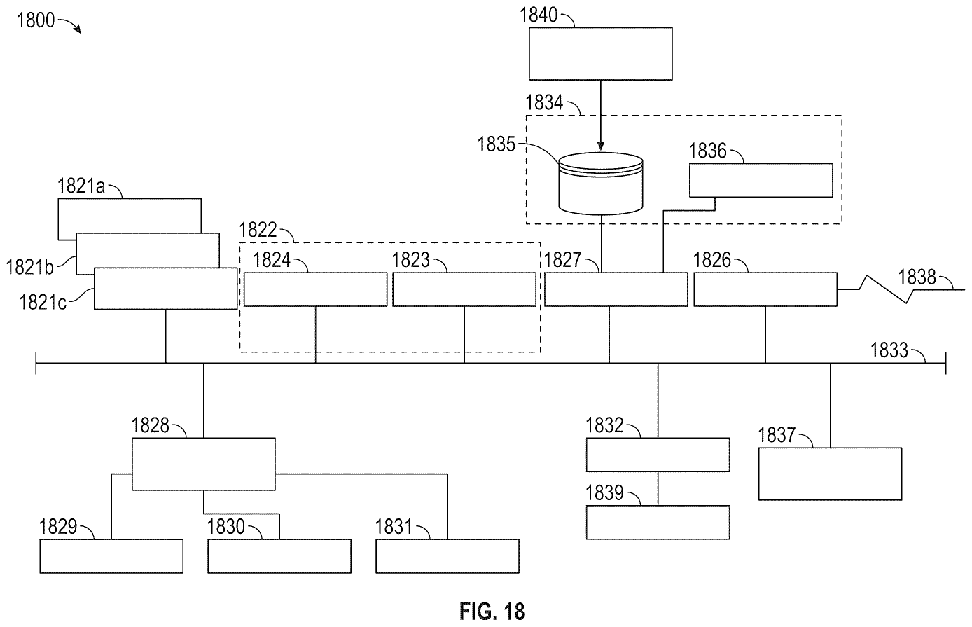

It is understood that one or more embodiments described herein is capable of being implemented in conjunction with any other type of computing environment now known or later developed. For example, FIG. 18 depicts a block diagram of a processing system 1800 for implementing the techniques described herein. In accordance with one or more embodiments described herein, the processing system 1800 is an example of a cloud computing node of a cloud computing environment. In examples, processing system 1800 has one or more central processing units (referred to also as “processors” or “processing resources” or “processing devices”) 1821a, 1821b, 1821c, etc. (collectively or generically referred to as processor(s) 1821 and/or as processing device(s)). In aspects of the present disclosure, each processor 1821 can include a reduced instruction set computer (RISC) microprocessor. Processors 1821 are coupled to a system memory 1822 and/or various other components via a system bus 1833. The system memory 1822 can include one or more temporary and/or persistent memory devices, such as a random access memory (RAM) 1823, a read-only memory (ROM) 1824, and/or the like, including combinations and/or multiples thereof. The system bus 1833 may include a basic input/output system (BIOS), which controls certain basic functions of processing system 1800.

Further depicted are an input/output (I/O) adapter 1827 and a network adapter 1826 coupled to system bus 1833. I/O adapter 1827 may be a small computer system interface (SCSI) adapter that communicates with a hard disk 1835 and/or a storage device 1836 or any other similar component. I/O adapter 1827, hard disk 1835, and storage device 1836 are collectively referred to herein as mass storage 1834. Operating system 1840 for execution on processing system 1800 may be stored in mass storage 1834. The network adapter 1826 interconnects system bus 1833 with an outside network 1838 enabling processing system 1800 to communicate with other such systems.

A display (e.g., a display monitor) 1839 is connected to system bus 1833 by display adapter 1832, which may include a graphics adapter to improve the performance of graphics intensive applications and a video controller. In one aspect of the present disclosure, adapters 1826, 1827, and/or 1832 may be connected to one or more I/O buses that are connected to system bus 1833 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 1833 via user interface adapter 1828 and display adapter 1832. A keyboard 1829, mouse 1830, and speaker 1831 may be interconnected to system bus 1833 via user interface adapter 1828, which may include, for example, a Super I/O chip integrating multiple device adapters into a single integrated circuit.

In some aspects of the present disclosure, processing system 1800 includes a graphics processing unit (GPU) 1837. Graphics processing unit 1837 is a specialized electronic circuit designed to manipulate and alter memory to accelerate the creation of images in a frame buffer intended for output to a display. In general, graphics processing unit 1837 is very efficient at manipulating computer graphics and image processing, and has a highly parallel structure that makes it more effective than general-purpose CPUs for algorithms where processing of large blocks of data is done in parallel.

Thus, as configured herein, processing system 1800 includes processing capability in the form of processors 1821, storage capability including the system memory 1822 and mass storage 1834, input means such as keyboard 1829 and mouse 1830, and output capability including speaker 1831 and display 1839. In some aspects of the present disclosure, a portion of system memory 1822 and mass storage 1834 collectively store the operating system 1840 to coordinate the functions of the various components shown in processing system 1800.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method for vehicle test case generation, the method comprising:
receiving at least one of a transactional level input/output (I/O) model based at least in part on a feature file and textual artifacts;
incrementally building behaviors from a base scenario to multiple scenarios;
identifying gaps in conditions and decisions expressions in the behaviors;
building system level behaviors;
generating additional scenarios based at least in part on the system level behaviors and the gaps in conditions and decisions expression in the behaviors;
generating a behavioral model based at least in part on the base scenario, the multiple scenarios, the behaviors, and the additional scenarios; and
causing at least one system of a vehicle to be tested based at least in part on a test case generated using the behavioral model.

2. The computer-implemented method of claim 1, wherein receiving the transactional level I/O model based at least in part on the feature file further comprises receiving the feature file or a feature file component.

3. The computer-implemented method of claim 1, wherein incrementally building behaviors from a base scenario to the multiple scenarios comprises:
reading in a first scenario of a plurality of scenarios;
extracting states and communicating agents from the first scenario;
calling a large language model (LLM) with a first customized prompt to covert the first scenario to a behavioral model type;
calling the LLM with a second customized prompt to create or to add to the behavioral model; and
iterating to a second scenario of the plurality of scenarios, and repeating the extracting and calling until each of the plurality of scenarios has been read.

4. The computer-implemented method of claim 3, wherein incrementally building behaviors from the base scenario to the multiple scenarios further comprises:
calling the LLM to check whether the behavioral model is complete; and
implementing a human-in-the-loop phase to enable updating and checking the behavioral model.

5. The computer-implemented method of claim 1, wherein incrementally building behaviors from the base scenario to the multiple scenarios is performed using a large language model (LLM)-based agent and is performed based in part on a model type and a prompt received from a prompt library.

6. The computer-implemented method of claim 1, wherein identifying the gaps in conditions and decisions expressions in the behaviors comprises:
identifying two or more conditions that occur at a same time; and
modifying the behavioral model to account for the two or more conditions that occur at the same time.

7. The computer-implemented method of claim 1, wherein identifying the gaps in conditions and decisions expressions in the behaviors comprises:
identifying an expression logical gap; and
modifying the behavioral model by adding missing transactions to account for the expression logical gap.

8. A processing system comprising:
a memory comprising computer readable instructions; and
a processing device for executing the computer readable instructions, the computer readable instructions controlling the processing system to perform operations for vehicle test case generation, the operations comprising:
receiving a transactional level input/output (I/O) model based at least in part on a feature file;
incrementally building behaviors from a base scenario to multiple scenarios;
identifying gaps in conditions and decisions expressions in the behaviors;
building system level behaviors;
generating additional scenarios based at least in part on the system level behaviors and the gaps in conditions and decisions expression in the behaviors;
generating a behavioral model based at least in part on the base scenario, the multiple scenarios, the behaviors, and the additional scenarios; and
causing at least one system of a vehicle to be tested based at least in part on a test case generated using the behavioral model.

9. The processing system of claim 8, wherein receiving the transactional level I/O model based at least in part on the feature file further comprises receiving the feature file or a feature file component.

10. The processing system of claim 8, wherein incrementally building behaviors from the base scenario to the multiple scenarios comprises:
reading in a first scenario of a plurality of scenarios;
extracting states and communicating agents from the first scenario;
calling a large language model (LLM) with a first customized prompt to covert the first scenario to a behavioral model type;
calling the LLM with a second customized prompt to create or to add to the behavioral model; and
iterating to a second scenario of the plurality of scenarios, and repeating the extracting and calling until each of the plurality of scenarios has been read.

11. The processing system of claim 10, wherein incrementally building behaviors from the base scenario to the multiple scenarios further comprises:
calling the LLM to check whether the behavioral model is complete; and
implementing a human-in-the-loop phase to enable updating and checking the behavioral model.

12. The processing system of claim 8, wherein incrementally building behaviors from the base scenario to the multiple scenarios is performed using a large language model (LLM)-based agent and is performed based in part on a model type and a prompt received from a prompt library.

13. The processing system of claim 8, wherein identifying the gaps in conditions and decisions expressions in the behaviors comprises:
identifying two or more conditions that occur at a same time; and
modifying the behavioral model to account for the two or more conditions that occur at the same time.

14. The processing system of claim 8, wherein identifying the gaps in conditions and decisions expressions in the behaviors comprises:
identifying an expression logical gap; and
modifying the behavioral model by adding missing transactions to account for the expression logical gap.

15. A computer program product comprising a computer readable storage medium having program instructions embodied therewith, the program instructions executable by at least one processor to cause the at least one processor to perform operations for vehicle test case generation, the operations comprising:
receiving a transactional level input/output (I/O) model based at least in part on a feature file;
incrementally building behaviors from a base scenario to multiple scenarios;
identifying gaps in conditions and decisions expressions in the behaviors;
building system level behaviors;
generating additional scenarios based at least in part on the system level behaviors and the gaps in conditions and decisions expression in the behaviors;
generating a behavioral model based at least in part on the base scenario, the multiple scenarios, the behaviors, and the additional scenarios; and
causing at least one system of a vehicle to be tested based at least in part on a test case generated using the behavioral model.

16. The computer program product of claim 15, wherein receiving the transactional level I/O model based at least in part on the feature file further comprises receiving the feature file or a feature file component.

17. The computer program product of claim 15, wherein incrementally building behaviors from the base scenario to the multiple scenarios comprises:
reading in a first scenario of a plurality of scenarios;
extracting states and communicating agents from the first scenario;
calling a large language model (LLM) with a first customized prompt to covert the first scenario to a behavioral model type;
calling the LLM with a second customized prompt to create or to add to the behavioral model; and
iterating to a second scenario of the plurality of scenarios, and repeating the extracting and calling until each of the plurality of scenarios has been read.

18. The computer program product of claim 17, wherein incrementally building behaviors from the base scenario to the multiple scenarios further comprises:
calling the LLM to check whether the behavioral model is complete; and
implementing a human-in-the-loop phase to enable updating and checking the behavioral model.

19. The computer program product of claim 15, wherein incrementally building behaviors from the base scenario to the multiple scenarios is performed using a large language model (LLM)-based agent and is performed based in part on a model type and a prompt received from a prompt library.

20. The computer program product of claim 15, wherein identifying the gaps in conditions and decisions expressions in the behaviors comprises:
identifying two or more conditions that occur at a same time;
modifying the behavioral model to account for the two or more conditions that occur at the same time;
identifying an expression logical gap; and
modifying the behavioral model by adding missing transactions to account for the expression logical gap.
